(19) United States
(12) Patent Application Publication
(10) Pub. No.: US 2026/0310894 A1
(43) Pub. Date: Oct. 8, 2026

(54) MODALITIES FOR PRETRAINED LANGUAGE MODELS

(71) Applicant: ADOBE INC., SAN JOSE, CA (US)

(72) Inventors: Sicheng Mo, Los Angeles, CA (US); Thao Nguyen, Madison, WI (US); Xun Huang, Pittsburgh, PA (US); Siddharth Srinivasan Iyer, San Francisco, CA (US); Yijun Li, Seattle, WA (US); Yuchen Liu, San Jose, CA (US); Abhishek Tandon, Santa Clara, CA (US); Elya Shechtman, Seattle, WA (US); Krishna Kumar Singh, San Jose, CA (US); Yuheng Li, San Jose, CA (US)

(21) Appl. No.: 19/169,258

(22) Filed: Apr. 3, 2025

(51) Int. Cl. G06F 40/284

(52) U.S. Cl. CPC G06F 40/284

(57) ABSTRACT

A method, apparatus, non-transitory computer readable medium, and system for generating a response includes obtaining an input prompt that includes an input media description. A language generation model generates a text token based on the input prompt. Subsequently, a media generation model generates a synthetic media based on the input prompt, wherein the synthetic media depicts a scene corresponding to the input description. A response to the input prompt generated based on the text token and the synthetic media is presented to the user.

### BACKGROUND

The following relates generally to machine learning, and more specifically to response generation using a machine learning model. Machine learning algorithms build a model based on sample data, known as training data, to make a prediction or a decision in response to an input without being explicitly programmed to do so. One area of application for machine learning is response generation.

For example, a machine learning model can be trained to predict features for an image in response to an input prompt, and then generate the image based on the predicted features. In some cases, the prompt can be used to perform complex image manipulation and compositing. In some examples, image generation provides for a user to edit an image and generate an image with desired features and therefore makes image generation easier for a layperson.

### SUMMARY

The present disclosure describes systems and methods for response generation. Embodiments of the present disclosure include a response generation apparatus that extends use of a pretrained language generation model for a multimodal task. In some cases, the pretrained language generation model is able to preserve their language capabilities while integrating vision specific information. The response generation apparatus comprises a fusion model that uses a dual-tower design for the language generation model and a media generation model with modality-specific weights.

A method, apparatus, and non-transitory computer readable medium for response generation are described. One or more aspects of the method, apparatus, and non-transitory computer readable medium include obtaining an input prompt that includes an input media description; generating, using a language generation model, a text token based on the input prompt; generating, using a media generation model, a synthetic media based on the input prompt, wherein the synthetic media depicts a scene corresponding to the input description; and generating a response to the input prompt by combining the synthetic media with text corresponding to the text token.

A method, apparatus, and non-transitory computer readable medium for response generation are described. One or more aspects of the method, apparatus, and non-transitory computer readable medium include obtaining an input prompt that includes an input media; generating, using a language generation model, a text token based on the input prompt; generating, using a media generation model, a synthetic media based on the input prompt, wherein the synthetic media is generated independent of the language generation model and depicts an element of the input media; and generating a response to the input prompt based on the text token and the synthetic media, wherein the response comprises a description of the input media.

An apparatus and system for response generation are described. One or more aspects of the apparatus and system include a memory component; a processing device coupled to the memory component, the processing device configured to perform operations comprising: obtaining an input prompt that includes an input media description; generating, using a language generation model, a text token based on the input prompt; generating, using a media generation model, a synthetic media based on the input prompt, wherein the synthetic media is generated independent of the language generation model and depicts a scene corresponding to the input image description; and generating a response to the input prompt based on the text token and the synthetic media.

### BRIEF DESCRIPTION OF THE DRAWINGS

FIG. 1 shows an example of a response generation system according to aspects of the present disclosure.

FIG. 2 shows an example of a method for response generation according to aspects of the present disclosure.

FIG. 3 shows an example of a response generation process according to aspects of the present disclosure.

FIG. 4 shows an example of a response generation process according to aspects of the present disclosure.

FIG. 5 shows an example of transformer network according to aspects of the present disclosure.

FIG. 6 shows an example of a latent diffusion process according to aspects of the present disclosure.

FIG. 7 shows an example of a diffusion transformer network according to aspects of the present disclosure.

FIG. 8 shows an example of a U-Net architecture according to aspects of the present disclosure.

FIG. 9 shows an example of a denoising diffusion process according to aspects of the present disclosure.

FIG. 10 shows an example of a method for response generation according to aspects of the present disclosure.

FIG. 11 shows an example of training the fusion model according to aspects of the present disclosure.

FIG. 12 shows an example of a method of training a machine learning model according to aspects of the present disclosure.

FIG. 13 shows an example of a method of training a diffusion model according to aspects of the present disclosure.

FIG. 14 shows an example of a computing device according to aspects of the present disclosure.

FIG. 15 shows an example of a response generation apparatus according to aspects of the present disclosure.

FIG. 16 shows an example of a machine learning model according to aspects of the present disclosure.

### DETAILED DESCRIPTION

Language generation systems perform language processing tasks and have been used for solving language related issues. However, existing language generation models are unable to cope with tasks with multiple modalities, such as audio, video, etc. For example, in case of a query including an image of a dog and an associated message such as “[image] is cute”, existing language generation systems are unable to accurately understand or reason the visual information. As a result, such language generation models are not able to generate multiple modalities (e.g., language, audio, image, etc.) simultaneously.

In some examples, an existing language generation system focuses on training a unified vision-language model from scratch. However, such systems use a high amount of computational resources and require retraining the model for each new modality. In some examples, an existing language generation model may align the text feature space with a pretrained vision encoder. However, such systems are prone to increased error due to restricted in-context learning and low inter-modal understanding. As a result, such systems have poor generation capabilities and low alignment among the multiple modalities.

By contrast, embodiments of the present disclosure include a response generation apparatus comprising a fusion model with strong multimodal alignment. The fusion model retains language capabilities of a pre-trained language generation model while adapting the language generation model with multimodal generation capability. In some cases, the fusion model is used to freeze weights of the language generation model. By freezing weights of the language generation model, embodiments of the present disclosure are able to preserve inherent capabilities of the language generation model.

According to an embodiment of the present disclosure, the fusion model comprises a media generation model (e.g., an image generation model). In some examples, the image generation model comprises a vision weight in each layer for processing visual information for the language generation model. By using the image generation model for processing vision information for the language generation model, embodiments of the present disclosure are able to align multimodal features (e.g., text feature and vision feature) at the input layer, the output layer, and the intermediate layers.

An embodiment of the present disclosure includes tower-based processing for each modality. In some cases, text is processed by the language generation model using a text tower which enables preservation of language capabilities. In some cases, an image is processed by the image generation model using a vision tower which processes the image for the language generation model. By implementing the tower-based processing for each modality separately, embodiments of the present disclosure are able to easily process additional modalities by incorporating an additional modality-specific tower.

An exemplary embodiment of the present disclosure includes a response generation apparatus that performs vision understanding. In some examples, a training component of the response generation apparatus creates an image understanding training dataset without introducing noise to the image data. In some cases, the training component uses the training dataset for training a unified (i.e., fusion) model. By performing vision understanding without noise data, embodiments are able to enhance image generation and image understanding capabilities due to increased semantic visual representation.

The response generation apparatus of the present disclosure adapts a pretrained large language model to different modalities while retaining the language capability of the language generation model. In some examples, the training component provides for learning of semantic visual representation resulting in enhanced image generation and image understanding abilities. In some cases, by learning the semantic visual representation, embodiments provide for cross-task synergy resulting in increased image understanding and enhanced image generation quality. Additionally, in some cases, the response generation apparatus effectively aligns visual features with an additional pre-trained representation. By performing the alignment between different modalities, embodiments enable fast convergence of the fusion model.

As used herein, the input prompt refers to a natural language description that defines the overall context in the image to be generated. In some cases, the input prompt includes a natural language description that defines a scene to be generated. In some cases, the input prompt includes a modality other than text (i.e., natural language). For example, the input prompt includes an audio, a video, or an image.

As used herein, a language generation model may refer to a machine learning-based model configured to generate responses (including text-based or image-based responses) based on input data. The language generation model may utilize deep learning architectures, such as transformer-based neural networks, recurrent neural networks (RNNs), or other sequence-processing models, to generate contextually relevant and semantically coherent output.

As used herein, a media generation model may refer to a machine learning-based model configured to generate a media item, such as an image, video, or audio, based on input data. The model may include machine learning architectures, such as neural networks, generative adversarial networks (GANs), transformer-based models, or a diffusion network. In some cases, the media generation model may utilize trained parameters, latent representations, or probabilistic sampling techniques to produce outputs that resemble or extend the input data while maintaining desired stylistic or structural attributes.

As used herein, a token refers to a portion of a text string. A token may include an entire word or a portion of a word. Additionally, as used herein, a token refers to a portion of an image. A token may include a patch of an image. For example, in case an image is split into patches of 10×10 tokens, the image is considered as being represented using 100 patches.

As used herein, the synthetic media refers to a synthetized audio, video, or image where the element (or a plurality of elements) are placed according to the constraints provided as input. Additionally, the synthetic media refers to the synthetized audio, synthetized video, or synthetized image where the element (or the plurality of elements) in the media item accurately align with the input prompt while ensuring a coherent composition.

As described herein, a response may be generated as an answer to the input prompt. For instance, a media generation model (e.g., an image generation model) generates a media based response for a dataset of input prompts. Additionally, for example, a language generation model generates a text-based response for a dataset of input prompts. For instance, the fusion model generates a multimodal response (i.e., comprising natural language based response, an image based response, an audio response, a video response, etc.).

By incorporating understanding-focused data into the fusion model, embodiments of the present disclosure are able to enhance quality of image generation while reducing image data noise. Accordingly, by reducing the noise, embodiments are able to enhance overall performance of image generation. Additionally, by maintaining the weights of the language generation model, embodiments of the present disclosure are able to extend to multiple modalities while using the language generation model capabilities. By initializing the language generation model with pre-determined weights, embodiments are able to significantly reduce computational costs while retaining knowledge of the language generation model.

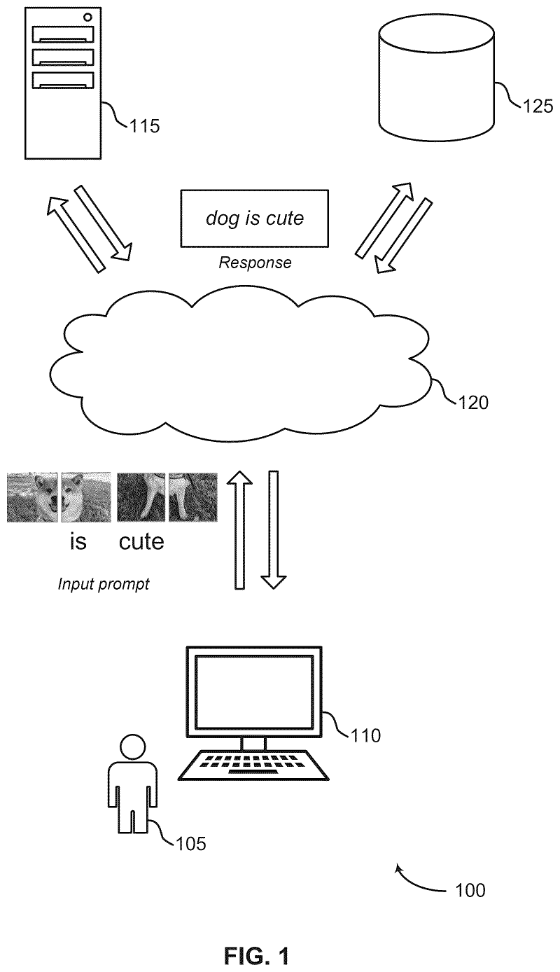

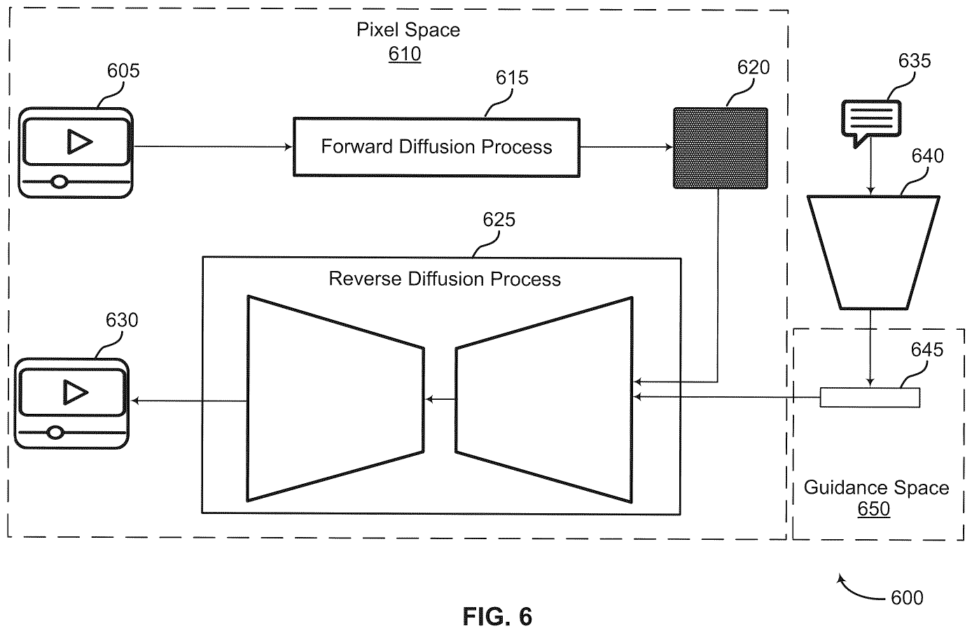

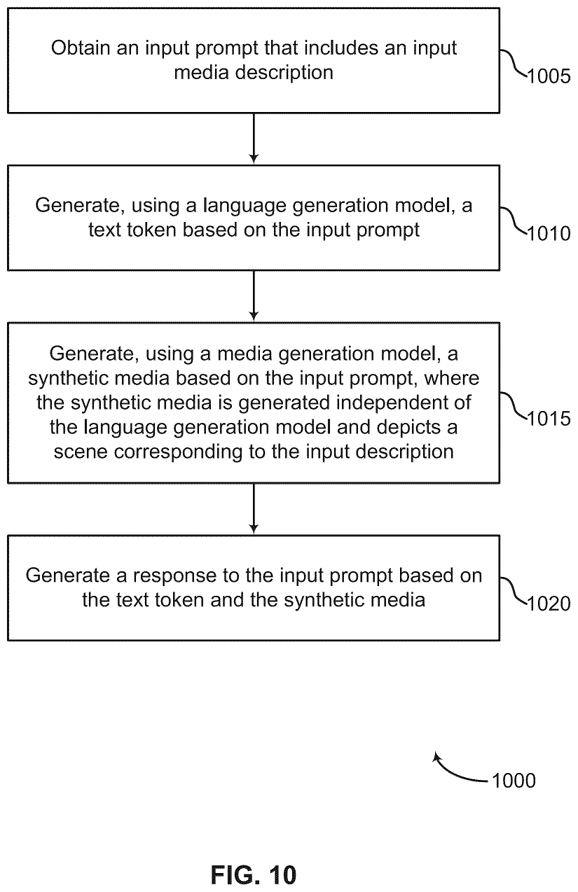

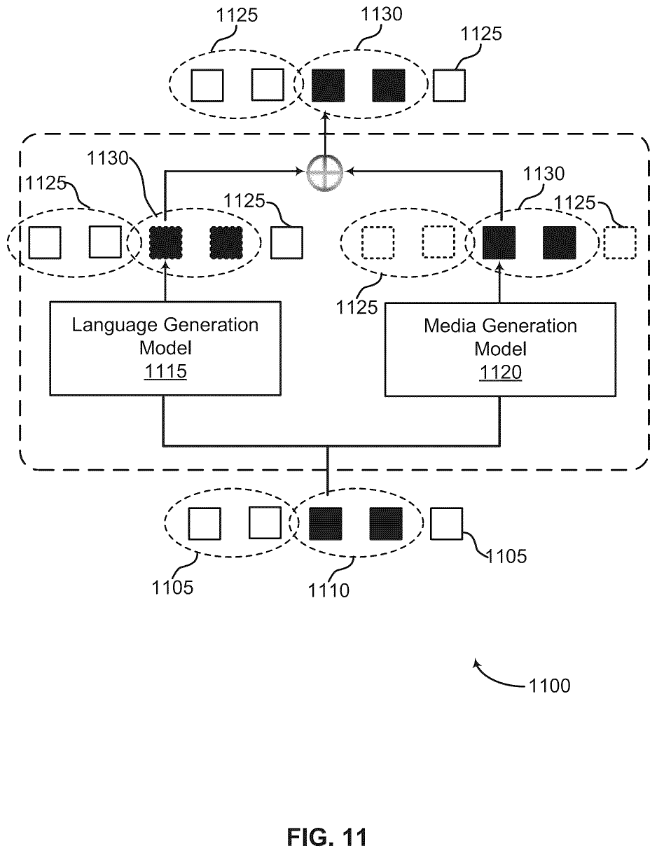

Embodiments of the present disclosure can be implemented in a response generation system. For example, the response generation system of the present disclosure takes an input prompt (e.g., including multiple modalities) and generates a response that accurately answers the query provided by the input prompt. Example applications regarding generating a response are provided with reference to FIGS. 1-4. Details regarding the architecture of the response generation apparatus are provided with reference to FIGS. 6-9 and 14-16. Details regarding an operation of the response generation apparatus are provided with reference to FIG. 10. Examples of a process for training the response generation apparatus are provided with reference to FIGS. 11-13.

### Response Generation System

A system and an apparatus for response generation are described with reference to FIGS. 1-9. FIG. 1 shows an example of a response generation system 100 according to aspects of the present disclosure. In one aspect, response generation system 100 includes user 105, user device 110, response generation apparatus 115, cloud 120, and database 125.

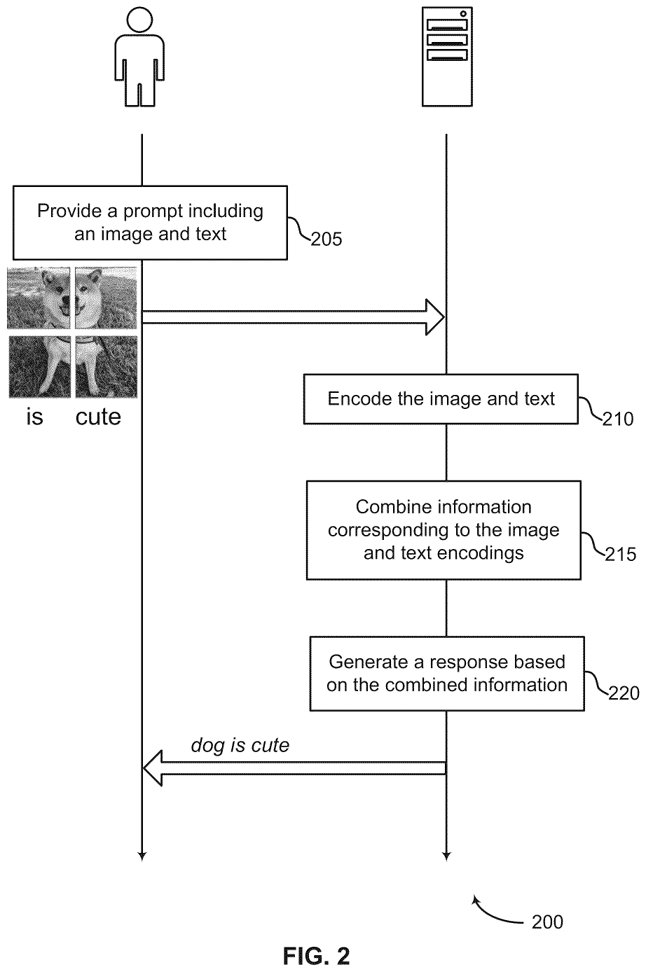

In the example of FIG. 1, user 105 provides a prompt including an image and a message to response generation apparatus 115 via a user interface provided on user device 110 by response generation apparatus 115. In some examples, the input prompt refers to a text-based (i.e., a natural language based) prompt. In some examples, the input prompt refers to a different modality, such as a video or an audio. However, embodiments are not limited thereto and the input prompt can comprise another modality or a combination thereof. As shown in FIG. 1, the input prompt comprises an image of a dog and a message (e.g., [image] is cute) based on which the user wants to generate a response using the response generation apparatus 115 of the present disclosure. User 105 is an example of, or includes aspects of, the corresponding element described with reference to FIG. 2.

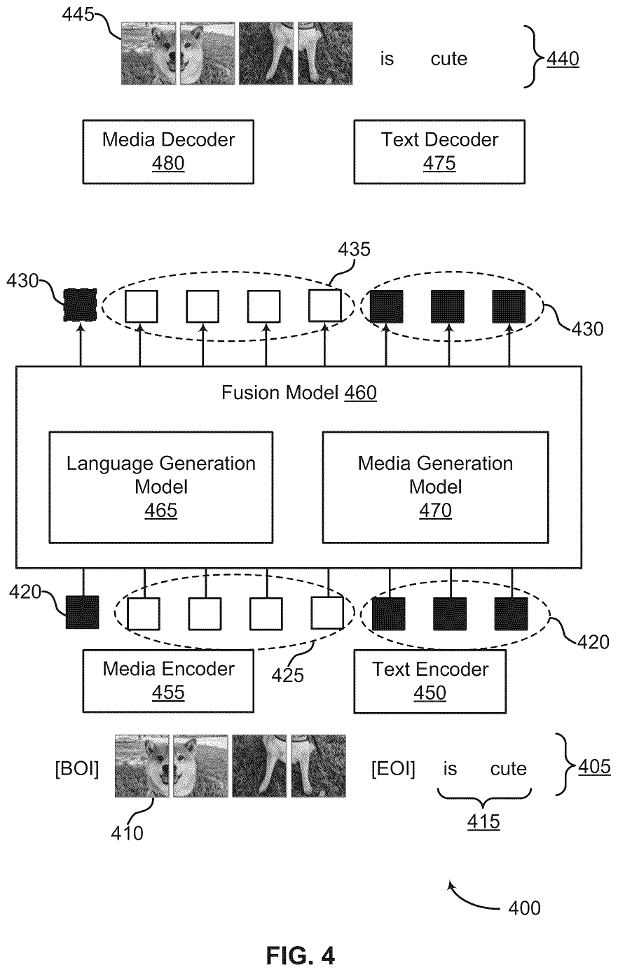

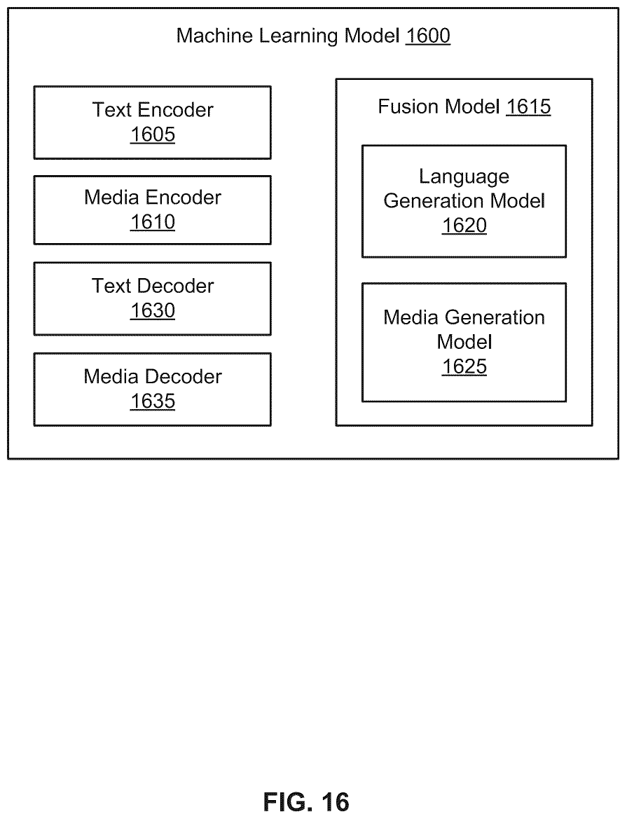

In some cases, the response generation apparatus 115 implements an encoder network (such as the encoder described with reference to FIG. 16), a fusion model (such as the fusion model described with reference to FIGS. 4, 10-11, and 16), and a decoder network (such as the decoder described with reference to FIG. 16) to generate a response that answers the query described by the input prompt. For example, as shown in FIG. 1, the user provides an input prompt (e.g., an [image] and a message “is cute”) to the response generation apparatus 115, for which the user wants to generate an enhanced message.

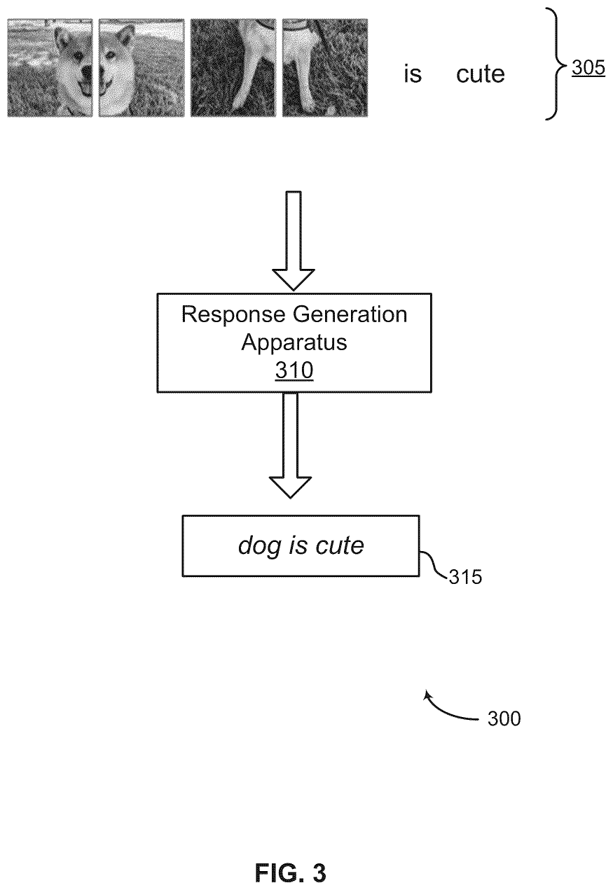

Response generation apparatus 115 provides for generation of a high-quality response based on the input prompt. In some cases, the response generation apparatus 115 takes an input prompt, combines the textual and visual information in the input prompt, and generates a response that answers the query provided by the input prompt. Response generation apparatus 115 is an example of, or includes aspects of, the corresponding element described with reference to FIG. 3.

For instance, the response generation apparatus 115 generates a response that includes multiple modalities (e.g., but not limited to, text, image, video, audio, etc.) or a combination of the multiple modalities. According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface) provided by response generation apparatus 115. In some aspects, the user interface provides for information (such as text, images (an input image or an input query), video, a prompt, a canvas, etc.) to be communicated between user 105 and response generation apparatus 115.

According to some aspects, a user device user interface enables user 105 to interact with user device 110. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

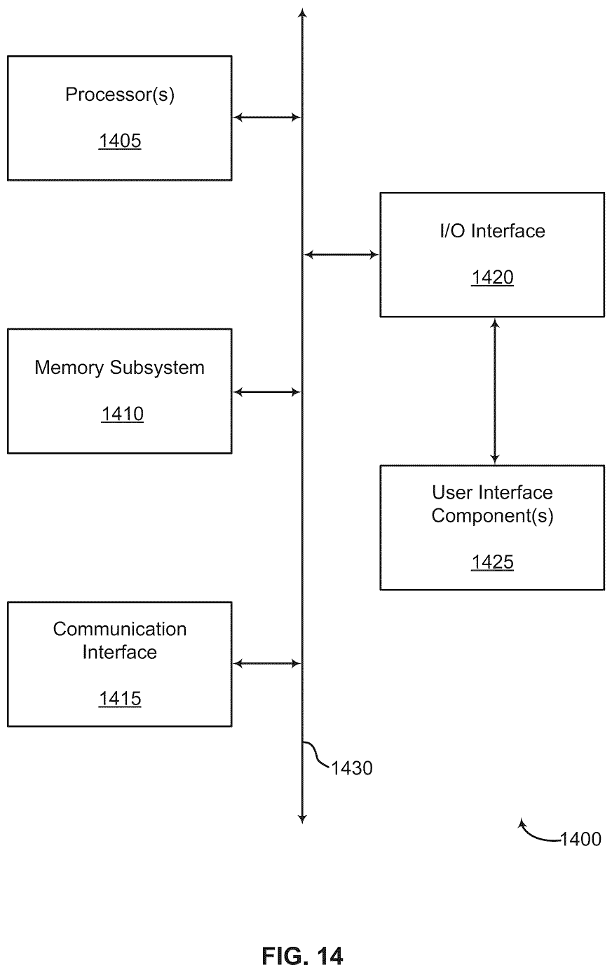

According to some aspects, response generation apparatus 115 includes a computer-implemented network. In some embodiments, the computer-implemented network includes a fusion model (such as the fusion model described with reference to at least FIGS. 4, 10-11, and 16). In some embodiments, response generation apparatus 115 also includes one or more processors, a memory subsystem, a communication interface, an I/O interface, one or more user interface components, and a bus as described with reference to FIG. 14. Additionally, in some embodiments, response generation apparatus 115 communicates with user device 110 and database 125 via cloud 120.

In some cases, response generation apparatus 115 is implemented on a server. A server provides one or more functions to users linked by way of one or more of various networks, such as cloud 120. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet. Some large cloud networks have functions distributed over multiple locations from central servers. A server is designated an edge server if it has a direct or close connection to a user. In some cases, cloud 120 is limited to a single organization. In other examples, cloud 120 is available to many organizations. In one example, cloud 120 includes a multi-layer communications network comprising multiple edge routers and core routers. In another example, cloud 120 is based on a local collection of switches in a single physical location. According to some aspects, cloud 120 provides communications between user device 110, response generation apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to response generation apparatus 115 and communicates with response generation apparatus 115 via cloud 120. According to some aspects, database 125 is included in response generation apparatus 115.

FIG. 2 shows an example of a method 200 for response generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

According to an embodiment of the present disclosure, a response generation apparatus (such as the response generation apparatus described with reference to FIGS. 1-4 and 14-16) provides an encoder (such as the encoders described with reference to FIG. 16), a fusion model (such as the fusion model described with reference to FIGS. 4, 10-11, and 16), and a decoder (such as the decoders described with reference to FIG. 16) that accurately generate a response to answer a query in the input prompt.

At operation 205, the system provides a prompt including an image and text. In some cases, the operations of this step refer to, or may be performed by, a user as described with reference to FIG. 1.

In some examples, the user-provided prompt describes a scene in natural-language (e.g., text) based on which a user (such as the user described in FIG. 1) wants to generate an image. In some examples, the user-provided prompt depicts a scene in an image based on which a user wants to generate text (e.g., caption describing the image). For example, the user provides a prompt instructing the response generation apparatus to generate a response that accurately answers a query in the prompt. As shown in FIG. 2, the user provides a prompt comprising an image of a dog and a partial natural language description such as “is cute” to the response generation apparatus via a user interface of a user device (such as a user interface of user device 110 described with reference to FIG. 1).

At operation 210, the system encodes the image and text. In some cases, the operations of this step refer to, or may be performed by, a response generation apparatus as described with reference to FIGS. 1, 3-4, and 15.

According to an embodiment of the present disclosure, the response generation apparatus obtains the user-provided prompt. In some examples, the response generation apparatus comprises a text encoder and a media encoder. In some examples, the response generation apparatus comprises a text encoder and an image encoder. For example, the text encoder tokenizes the text input to generate a text token. Additionally, for example, the image encoder tokenizes the image input to generate an image token. However, embodiments are not limited thereto, and the user-provided prompt can include any other modality (or a combination of modalities). Further details regarding the tokenization operation are provided with reference to FIGS. 4 and 10-11.

At operation 215, the system combines information corresponding to the image and text encodings. In some cases, the operations of this step refer to, or may be performed by, a response generation apparatus as described with reference to FIGS. 1, 3-4, and 15.

The response generation apparatus comprises a fusion model including a language generation model and a media generation model. In some examples, the fusion model including the language generation model and the media generation model are arranged in a dual tower architecture of a transformer block designed for multimodal integration. The tokenized input embeddings (e.g., text token and image token generated at operation 210) are used as input by the dual tower architecture.

For example, the language generation model and the media generation model process the input tokens. In some cases, each of the language generation model and the media generation model process the same input embeddings. In some examples, the media generation model processes the image tokens conditioned on textual features for response generation. An output of the language generation model and an output of the media generation model are selectively combined to generate an output sequence. Further details regarding this operation are provided with reference to FIGS. 10-11.

At operation 220, the system generates a response based on the combined information. In some cases, the operations of this step refer to, or may be performed by, a response generation apparatus as described with reference to FIGS. 1, 3-4, and 15.

In some examples, the response generation apparatus comprises a text decoder and an image decoder. For example, the text decoder decodes a text embedding in the output sequence (e.g., the output sequence generated at operation 215) to generate discrete tokens. For example, the image decoder decodes the image embeddings in the output sequence to generate pixel values. As shown with reference to FIG. 2, the response generation apparatus generates a response based on the text tokens and the pixel values.

In some examples, the response generation apparatus is able to understand, reason, and generate an image. As shown in FIG. 2, the response generation apparatus processes the text and image simultaneously to generate the response (e.g., text-based response) “dog is cute” as desired by the user. However, embodiments are not limited thereto, and the response generation apparatus generates a response including any modality, as desired by the user. The generated response is provided to the user via a user interface of the user device (such as user device 110 as described in FIG. 1). Further details regarding the generation of the response are provided with reference to at least FIGS. 10-11.

FIG. 3 shows an example of an image generation process 300 according to aspects of the present disclosure. Image generation process 300 is an example of, or includes aspects of, the corresponding element described with reference to FIG. 4. In one aspect, image generation process 300 includes input prompt 305, response generation apparatus 310, and response 315.

According to an embodiment, user (such as user described with reference to FIGS. 1-2) provides an input prompt (such as input prompt described with reference to FIGS. 1-2). In some examples, the input prompt comprises a modality, such as an image or text (such as a natural language based prompt). In some examples, input prompt 305 comprises a combination of modalities, including but not limited to, text, image, audio, video, etc. For example, the user wants to generate a response that answers the input prompt.

In some cases, user provides input prompt comprising a modality to response generation apparatus 310 via a user interface of the response generation apparatus 310. For example, as shown in FIG. 3, user provides input prompt 305 comprising an image of a dog and a partial message such as “is cute” to response generation apparatus 310. Input prompt 305 is an example of, or includes aspects of, the corresponding element described with reference to FIG. 4.

Response generation apparatus 310 (such as the response generation apparatus described with reference to at least FIGS. 1-2, 4, and 15) of the present disclosure receives the input prompt comprising a modality (or a combination of modalities). In some cases, the response generation apparatus 310 generates response 315 based on a combination of modalities mentioned in input prompt 305.

For example, response generation apparatus 310 comprises a fusion model (such as the fusion model described with reference to FIGS. 10-11 and 16) that retains language capabilities of a pre-trained language generation model while adapting the language generation model with multimodal generation capability. In some cases, response generation apparatus 310 comprises a media generation network (such as the media generation network described with reference to FIGS. 4-9 performing processes such as described with reference to FIGS. 10-11) with a vision weight in each layer for processing visual information for the language generation model.

By separately processing each modality (such as text or vision as described with reference to FIG. 11), embodiments of the present disclosure are able to easily process additional modalities. Response generation apparatus 310 is an example of, or includes aspects of, the corresponding element described with reference to FIG. 1. Response 315 is an example of, or includes aspects of, the corresponding element described with reference to FIG. 4.

FIG. 4 shows an example of a response generation process 400 according to aspects of the present disclosure. Response generation process 400 is an example of, or includes aspects of, the corresponding element described with reference to FIG. 3.

In one aspect, response generation process 400 includes input prompt 405, input text token 420, input media token 425, text token 430, media token 435, and response 440. In one aspect, response generation apparatus (such as the response generation apparatus described with reference to FIGS. 1-3 and 15) comprises text encoder 450, media encoder 455, fusion model 460, text decoder 475, and media decoder 480.

According to an embodiment of the present disclosure, user (such as the user described with reference to FIGS. 1-2) provides input prompt 405 to response generation apparatus via a user interface (such as the user interface described with reference to FIGS. 1 and 14-15) of a user device. In some cases, the input prompt 405 comprises a modality. In some cases, the input prompt 405 comprises a combination of modalities.

Input prompt 405 is an example of, or includes aspects of, the corresponding element described with reference to FIG. 3. In one aspect, input prompt 405 includes input media 410 and input media description 415. For example, as shown in FIG. 4, input prompt 405 includes input media 410 (e.g., an image of a dog) and a partial natural-language description (e.g., “is cute”) associated with the image.

In some cases, text encoder 450 tokenizes text media description 415 to generate input text token 420. In some cases, media encoder 455 generates a latent representation corresponding to input media 410. In some cases, media encoder 455 encodes the latent representations to generate an input media token 425.

According to an embodiment of the present disclosure, the response generation apparatus comprises fusion model 460. For example, fusion model 460 processes input media token 425 and input text token 420 in a single model. In one aspect, fusion model 460 includes language generation model 465 and media generation model 470. In some cases, fusion model 460 processes input media token 425 and input text token 420 using a dual-tower based architecture of the transformer block. For instance, language generation model 465 processes input text token 420 to generate text token 430. For instance, media generation model 470 processes input media token 425 to generate media token 435. Further details regarding operation of the fusion model and the dual-tower architecture are described with reference to FIGS. 10-11.

In some cases, media decoder 480 uses a linear regression head to convert the media token 435 to a continuous latent. Subsequently, for example, media decoder 480 uses a latent variational autoencoder (VAE) decoder to decode the continuous latent to a pixel value. In some cases, text decoder 475 uses a linear classification head to convert text token 430 into a discrete token.

Input text token 420 is an example of, or includes aspects of, the corresponding element described with reference to FIG. 11. Input media token 425 is an example of, or includes aspects of, the corresponding element described with reference to FIG. 11. Text token 430 is an example of, or includes aspects of, the corresponding element described with reference to FIG. 11. Media token 435 is an example of, or includes aspects of, the corresponding element described with reference to FIG. 11. Response 440 is an example of, or includes aspects of, the corresponding element described with reference to FIG. 3. In one aspect, response 440 includes synthetic media 445.

Language generation model 465 is an example of, or includes aspects of, the corresponding element described with reference to FIGS. 11 and 16. Media generation model 470 is an example of, or includes aspects of, the corresponding element described with reference to FIGS. 11 and 16. Text encoder 450 and media encoder 455 are examples of, or include aspects of, the corresponding element described with reference to FIG. 16. Text decoder 475 and media decoder 480 are examples of, or include aspects of, the corresponding element described with reference to FIG. 16.

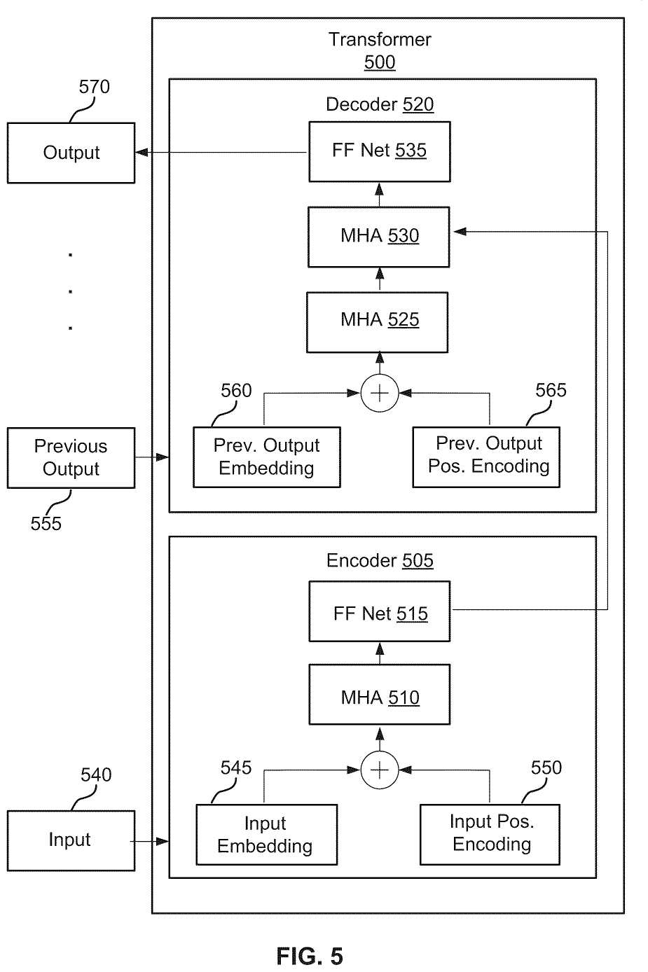

FIG. 5 shows example of a transformer network 500 according to aspects of the present disclosure. The example shown includes transformer 500, encoder 505, decoder 520, input 540, input embedding 545, input positional encoding 550, previous output 555, previous output embedding 560, previous output positional encoding 565, and output 570. According to some aspects, encoder 505 is implemented as a video encoder of a multi-modal encoder. According to some aspects, encoder 505 is implemented as a text encoder of conditional text encoder. According to some aspects, transformer 500 is implemented in the media generation model (such as the media generation model described with reference to FIGS. 6-9).

In some cases, encoder 505 includes multi-head self-attention sublayer 510 and feed-forward network sublayer 515. In some cases, decoder 520 includes first multi-head self-attention sublayer 525, second multi-head self-attention sublayer 530, and feed-forward network sublayer 535.

In some cases, encoder 505 is configured to map input 540 (for example, a text prompt) to a sequence of continuous representations that are fed into decoder 520. In some cases, decoder 520 generates output 570 (e.g., a prediction of an output sequence of words or tokens) based on the output of encoder 505 and previous output 555 (e.g., a previously predicted output sequence), which allows for the use of autoregression.

For example, in some cases, encoder 505 parses input 540 into tokens and vectorizes the parsed tokens to obtain input embedding 545, and adds input positional encoding 550 (e.g., positional encoding vectors for input 540 of a same dimension as input embedding 545) to input embedding 545. In some cases, input positional encoding 550 includes information about relative positions of words or tokens in input 540.

In some cases, encoder 505 comprises one or more encoding layers that generate contextualized token representations, where each representation corresponds to a token that combines information from other input tokens via self-attention mechanism. In some cases, each encoding layer of encoder 505 comprises a multi-head self-attention sublayer (e.g., multi-head self-attention sublayer 510). In some cases, the multi-head self-attention sublayer implements a multi-head self-attention mechanism that receives different linearly projected versions of queries, keys, and values to produce outputs in parallel. In some cases, each encoding layer of encoder 505 also includes a fully connected feed-forward network sublayer (e.g., feed-forward network sublayer 515) comprising two linear transformations surrounding a Rectified Linear Unit (ReLU) activation:

$$F F N ( x ) = R e L U ( {W}_{1} x + {b}_{1} ) {W}_{2} + {b}_{2} \qquad ( 1 )$$

In some cases, each layer employs different weight parameters (W₁, W₂) and different bias parameters (b₁, b₂) to apply a same linear transformation each word or token in input 540.

In some cases, each sublayer of encoder 505 is followed by a normalization layer that normalizes a sum computed between a sublayer input x and an output sublayer (x) generated by the sublayer:

$$l a y e r n o r m ( x + s u b l a y e r ( x ) ) \qquad ( 2 )$$

In some cases, encoder 505 is bidirectional because encoder 505 attends to each word or token in input 540 regardless of a position of the word or token in input 540.

According to some aspects, encoder 505 functions as a text encoder of the conditional text encoder. In an example, conditional text encoder splits an input text into fixed-size segments, generates a linear embedding of each of the segments, adds position embeddings to each of the linear embeddings, and provides the resulting sequence of vectors as input 540 to encoder 505.

In some cases, decoder 520 comprises one or more decoding layers (e.g., six decoding layers). In some cases, each decoding layer comprises three sublayers including a first multi-head self-attention sublayer (e.g., first multi-head self-attention sublayer 525), a second multi-head self-attention sublayer (e.g., second multi-head self-attention sublayer 530), and a feed-forward network sublayer (e.g., feed-forward network sublayer 535). In some cases, each sublayer of decoder 520 is followed by a normalization layer that normalizes a sum computed between a sublayer input x and an output sublayer (x) generated by the sublayer.

In some cases, decoder 520 generates previous output embedding 560 of previous output 555 and adds previous output positional encoding 565 (e.g., position information for words or tokens in previous output 555) to previous output embedding 560. In some cases, each first multi-head self-attention sublayer receives the combination of previous output embedding 560 and previous output positional encoding 565 and applies a multi-head self-attention mechanism to the combination. In some cases, for each word in an input sequence, each first multi-head self-attention sublayer of decoder 520 attends only to words preceding the word in the sequence, and so a prediction of transformer 500 for a word at a particular position only depends on known outputs for a word that came before the word in the sequence. For example, in some cases, each first multi-head self-attention sublayer implements multiple single-attention functions in parallel by introducing a mask over values produced by the scaled multiplication of matrices Q and K by suppressing matrix values that would otherwise correspond to disallowed connections.

In some cases, each second multi-head self-attention sublayer implements a multi-head self-attention mechanism similar to the multi-head self-attention mechanism implemented in each multi-head self-attention sublayer of encoder 505 by receiving a query Q from a previous sublayer of decoder 520 and a key K and a value V from the output of encoder 505, allowing decoder 520 to attend to each word in the input 540.

In some cases, each feed-forward network sublayer implements a fully connected feed-forward network similar to feed-forward network sublayer 515. In some cases, the feed-forward network sublayers are followed by a linear transformation and a softmax to generate a prediction of output 570.

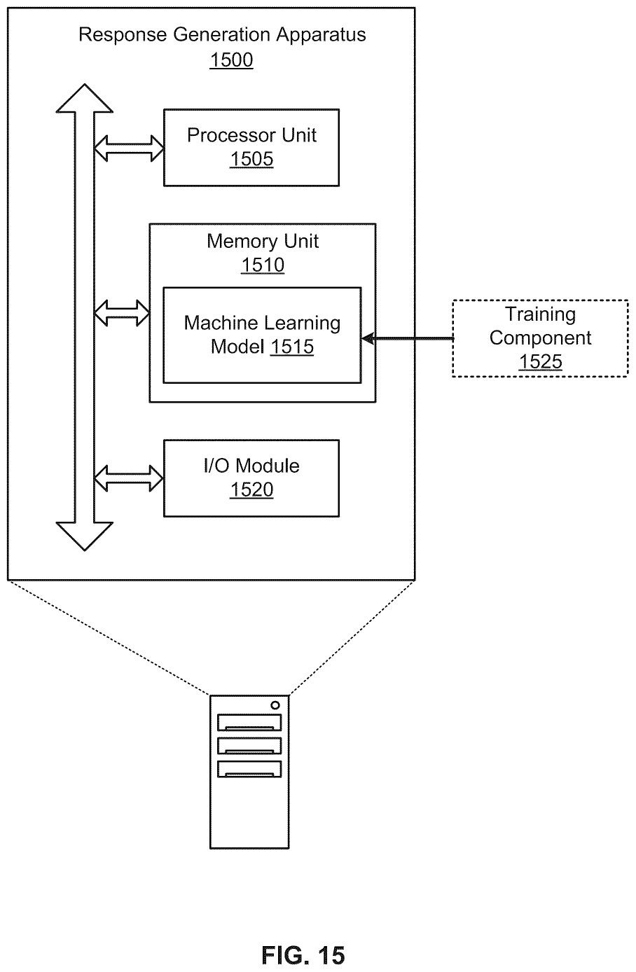

FIG. 6 shows an example of a guided diffusion model 600 according to aspects of the present disclosure. In some examples, guided diffusion model 600 describes the operation and architecture of the machine learning model 1515 described with reference to FIG. 15. The guided latent diffusion model 600 depicted in FIG. 6 is an example of, or includes aspects of, a media generation model as described herein.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided latent diffusion model 600 may take an original media item 605 in a pixel space 610 as input and apply forward diffusion process 615 to gradually add noise to the original media item 605 to obtain noisy media item 620 at various noise levels.

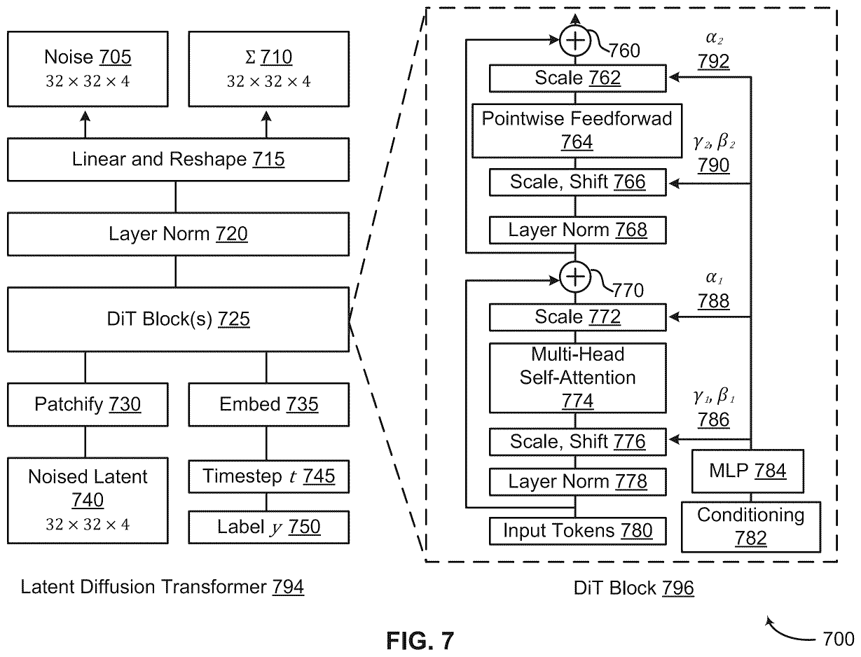

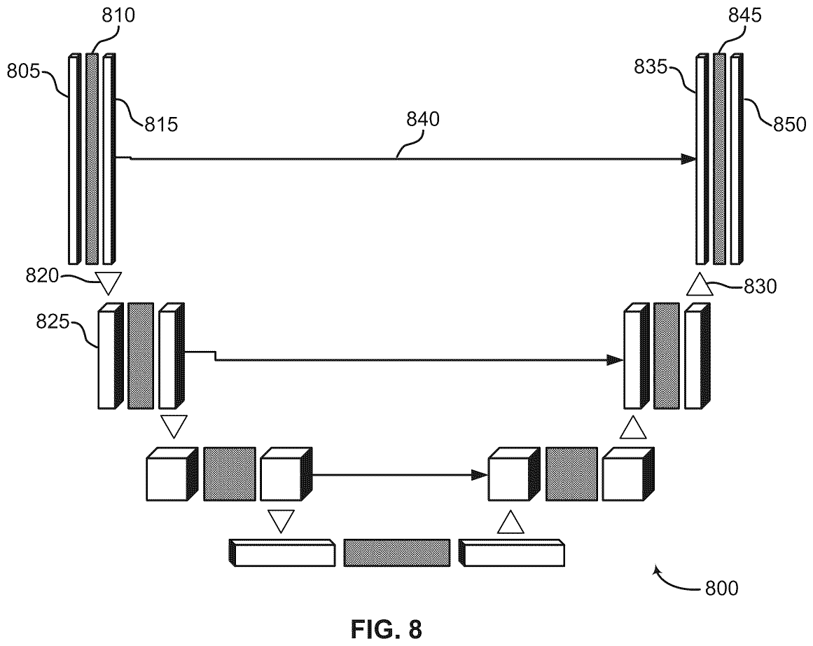

Next, a reverse diffusion process 625 (e.g., a diffusion transformer described in FIG. 7 or a U-Net described in FIG. 8) gradually removes the noise from the noisy media item 620 at the various noise levels to obtain an output media item 630. In some cases, an output media item 630 is created from each of the various noise levels. The output media item 630 can be compared to the original media item 605 to train the reverse diffusion process 625.

The reverse diffusion process 625 can also be guided based on a text prompt 635, or another guidance prompt, such as an image, a layout, a segmentation map, etc. The text prompt 635 can be encoded using a text encoder 665 (e.g., a multimodal encoder) to obtain guidance features 645 in guidance space 650. The guidance features 645 can be combined with the noisy media item 620 at one or more layers of the reverse diffusion process 625 to ensure that the output media item 630 includes content described by the text prompt 635. For example, guidance features 645 can be combined with the noisy features using a cross-attention block within the reverse diffusion process 625.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item. DDIM is an example of, or includes aspects of, the corresponding element described with reference to FIGS. 2, 5, 7-9, and 12-14.

FIG. 7 shows an example of a diffusion transformer (DiT) architecture 700 according to aspects of the present disclosure. The example shown includes predicted noise 705, predicted covariance 710, linear and reshape layers 715, normalization layer 720, DiT block(s) 725, patchify operation 730, embedding 735, noised latent 740, timestep information 745, label information 750, and an implementation of one block in the DiT block(s) 725 by a DiT Block 796. The DiT Block 796 includes: second residual connection 760, second scaling operations 762, feed-forward network 764, post-normalization second scaling and shifting 766, second normalization 768, first residual connection 770, first scaling operations 772, self-attention 774, post-normalization first scaling and shifting 776, first normalization 778, input tokens 780, conditioning tokens 782, multi-layer perceptron (MLP) 784, post-normalization first scaling and shifting parameters 786, first scaling parameter 788, post-normalization second scaling and shifting parameters 790, and second scaling parameter 792. In some embodiments, the architecture employes an Latent Diffusion Transformer 794. In some embodiments, DiT Block 796 employs an “adaLN-Zero” technique.

Diffusion Transformers (DiTs) is a popular architecture for diffusion models and is designed to be structurally faithful to standard transformer architecture. DiT incorporates transformer structures' scaling properties. For training denoising diffusion probabilistic models (DDPMs) of images (e.g., spatial representations of images), DiT is based on a Vision Transformer (ViT) architecture which operates on sequences of patches. DiT processes images by dividing them into patches, converting these patches into tokens, and applying attention mechanisms to model relationships between different regions of the image. This approach allows the model to capture both local and long-range dependencies in the image generation process.

In some cases, input to DiT is a spatial representation z. For 256×256×3 images, z has shape 32×32×4. A first layer of a DiT is to carry out patchify operation, where the DiT divides an input image into patches and converts the patches (a form of spatial input) into a sequence of T tokens, each of dimension d, by linearly embedding each patch in the input. Following the patchify process, ViT frequency-based positional embeddings are applied to all input tokens. In some cases, the number of tokens T created by patchify is determined by a patch size hyperparameter p. In some cases, T=(I/p)², where I is another shape parameter, thus halving p will quadruple T, which in some cases at least quadruples total of transformer Giga Floating Point Operations (Gflops). In some examples, changing p has no impact on downstream parameter counts, i.e., parameter counts in downstream layers of DiT is independent from p. In some examples, p=2, 4 or 8. Various patch sizes, transformer block architectures and model sizes are implemented.

Following Patchify operation, attention mechanisms are applied to model relationships between different regions of the image in one or more DiT blocks. In addition to noised image inputs, diffusion models sometimes process additional conditional information such as noise timesteps t, class labels c, natural language information, etc. Four variants of transformer blocks for processing conditional inputs including both input information and conditional information are described below.

In some cases, DiT blocks in the DiT network are implemented using adaptive layer norm (adaLN) blocks. Following adaptive normalization layers in generative adversarial networks (GANs) and conventional diffusion models with U-Net backbones, in some examples, standard normalization layers in transformer blocks are replaced with adaptive layer norm (adaLN). Rather than directly learning dimension-wise scale y and shift parameters β, in adaLN the system regresses y and β from a sum of the embedding vectors of the noise timesteps t and the class labels c. An adaLN adds relatively small numbers of Gflops and is more efficient. Additionally, adaLN is a conditioning mechanism that applies a same function to all tokens.

In some cases, DiT blocks in the DiT network are implemented using adaLN-Zero blocks, which leverages zero-initialization techniques. In Residual Networks (ResNets), initializing each residual block as the identity function x→x is beneficial. In some examples, zero-initializing a final batch norm scale factor y in each block accelerates large-scale training in supervised learning settings. Diffusion models based on U-Nets use a similar initialization strategy, zero-initializing final convolutional layer in each block prior to residual connections. An adaLN-Zero block is modified from an adaLN block using similar zero-initialization techniques. In addition to regressing the dimension-wise scale y and the shifting parameters β, the system also regresses dimension-wise scaling parameters as that are applied immediately prior to residual connections within the DiT block. The network initializes a multi-layer perceptron (MLP) to output a zero-vector for all αs; this initializes an entire DiT block as the identity function. As with the adaLN block, adaLNZero adds negligible Gflops to the model.

In some cases, DiT blocks in the DiT network are implemented using in-context conditioning, where vector embeddings of t and c are appended as two additional tokens in the input sequence, and after a final block, the network removes the two conditioning tokens from the sequence.

In some cases, DiT blocks in the DiT network include cross-attention blocks. The DiT network concatenates the embeddings of t and c into a length-two sequence, separate from the image token sequence. The transformer block is modified to include an additional multi-head cross-attention layer following the multi-head self-attention block.

In some cases, the DiT network includes a sequence of N DiT blocks, each operating at a hidden dimension size d. Following ViT, the DiT network uses standard transformer configs that jointly scale N, d and attention heads. In some examples, Small(S), Base (B), Large (L) variants, XLarge (XL) variants of model sizes are implemented. Small or Base model sizes have N=12 layers of DiT blocks, Large model sizes have 24 layers of DiT blocks. XLarge model sizes have 28 layers of DiT blocks.

After a final DiT block, the DiT network decodes the sequence of image tokens into an output noise prediction and an output diagonal covariance prediction. Both outputs have shape equal to an original spatial input. Standard linear decoder is utilized to decode, wherein a final normalization layer (or adaptive normalization layer if the DiT block is an adaLN block) and linearly decode each token into a p×p×2C tensor, where C is a number of channels in the spatial input to the DiT network and p is the patch size hyperparameter. Finally, decoded tokens are rearranged into their original spatial layout to get the predicted noise and covariance.

The architecture 700, in some cases, employs a Latent Diffusion Transformer 794. The architecture 700 processes noised latent 740, which may be a noised version of an input image encoded in a latent space. Patchify operation 730 divides the noised latent into a sequence of patches that are processed as tokens. The tokens are vector representations of each patch of the image in latent space, and are adjusted through attention processes. Each of the tokens also receives timestep information 745 and label information 750 and, accordingly, their embedding 735, which encodes the current denoising timestep and class labels as conditional information. In some cases, embedding 735 is referred to as conditional embedding or conditional information embedding. In some cases, a positional embedding which encodes each token's spatial position in the image is applied to the patchified input tokens at the patchify operations 730. In some examples the positional embedding is ViT frequency-based positional embedding. The input tokens 780 generated by the patchify operation 730 and the conditioning tokens 782 generated by the embedding 735 are processed through N DiT block(s) 725, where N may be 12, 24 or 28. Other values of N may be used. In some cases, conditional tokens refer to tokens generated based on embedding 735 encoding timestep information 745 and label information 750.

Each of the DiT block(s) 725 includes multiple processing stages. DiT Block 796 illustrates an embodiment of one block in the DiT block(s) 725. In some embodiments, the DiT Block 796 is an example of, or includes aspects of, the adaLN-Zero block. In some cases, input tokens 780 interact with the conditioning tokens 782 through multiple attention mechanisms. Particularly, after first normalization 778 applied to the input tokens and MLP 784 to the conditional tokens, MLP 784 generates or updates post-normalization first scaling and shifting parameters 786, denoted as γ₁, β₁, for post-normalization first scaling and shifting 776 to scale and shift the output of first normalization 778 accordingly. As the normalized input tokens obtained from first normalization 778 are scaled and shifted at post-normalization first scaling and shifting 776 using the conditional information carried as least in γ₁, β₁, this allows the input information and conditional information to interact. Self-attention 774 allows the scaled and shifted normalized input tokens, namely the output from post-normalization first scaling and shifting 776, to attend to each other. MLP 784 also generates or updates first scaling parameter 788 denoted as α₁ for first scaling operations 772 to scale the output of self-attention 774 (e.g., multi-head self-attention), further interacting the input information and conditional information. The input tokens 780 is then summed with the output of first scaling operations 772 at first residual connection 770. In some examples, α₁ has initial values 0, and the DiT Block 796 is initialized as the identity function.

A similar process is performed in a second half of the DiT Block 796. MLP 784 generates or updates post-normalization second scaling and shifting parameters 790, denoted as γ₂, β₂, for post-normalization second scaling and shifting 766 to scale and shift the output of second normalization 768 accordingly. As the output from second normalization 768 is scaled and shifted using the conditional information carried at least in γ₂, β₂, this allows the input information and conditional information to further interact. Feed-forward network 764 then processes the scaled and shifted output from post-normalization second scaling and shifting 766. MLP 784 also generates or updates second scaling parameter 792 denoted as α₂ for second scaling operations 762 to scale the output of feed-forward network 764, further interacting the input information and conditional information. In some cases, the feed-forward network 764 is a pointwise feed-forward network. The output from first residual connection 770 is then summed with the output of second scaling operations 762 at second residual connection 760, and the result is the final output of DiT Block 796. In some examples, α₂ has initial values 0, and the DiT Block 796 is initialized as the identity function. This process repeats for each DiT block in the sequence.

After processing through all DiT block(s) 725, the outputs undergo normalization layer 720 followed by linear and reshape layers 715. The final output is the predicted noise 705, which represents the model's prediction of the noise that was added to initially create the noised latent 740, and the predicted covariance 710, which represents the model's prediction of the covariance. The predicted noise 705 is removed from noised latent 740 at each diffusion timestep, and the predicted covariance may affect how noise is removed or resampled in the reverse or denoising process. At the end of the denoising schedule, the latent sample is decoded to generate the synthetic image in pixel space.

FIG. 8 shows an example of a U-Net 800 according to aspects of the present disclosure. In some examples, U-Net 800 is an example of the component that performs the reverse diffusion process 625 of guided diffusion model 600 described with reference to FIG. 6 and includes architectural elements of the machine learning model 1515 described with reference to FIG. 15. The U-Net 800 depicted in FIG. 8 is an example of, or includes aspects of, the architecture used within the reverse diffusion process described with reference to FIG. 6.

In some examples, diffusion models are based on a neural network architecture known as a U-Net. The U-Net 800 takes input features 805 having an initial resolution and an initial number of channels and processes the input features 805 using an initial neural network layer 810 (e.g., a convolutional network layer) to produce intermediate features 815. The intermediate features 815 are then down-sampled using a down-sampling layer 820 such that down-sampled features 825 features have a resolution less than the initial resolution and a number of channels greater than the initial number of channels.

This process is repeated multiple times, and then the process is reversed. That is, the down-sampled features 825 are up-sampled using up-sampling process 830 to obtain up-sampled features 835. The up-sampled features 835 can be combined with intermediate features 815 having the same resolution and number of channels via a skip connection 840. These inputs are processed using a final neural network layer 845 to produce output features 850. In some cases, the output features 850 have the same resolution as the initial resolution and the same number of channels as the initial number of channels.

In some cases, U-Net 800 takes additional input features to produce conditionally generated output. For example, the additional input features could include a vector representation of an input prompt. The additional input features can be combined with the intermediate features 815 within the neural network at one or more layers. For example, a cross-attention module can be used to combine the additional input features and the intermediate features 815. U-Net architecture is an example of, or includes aspects of, the corresponding element described with reference to FIGS. 2, 5-7, 9, and 12-14.

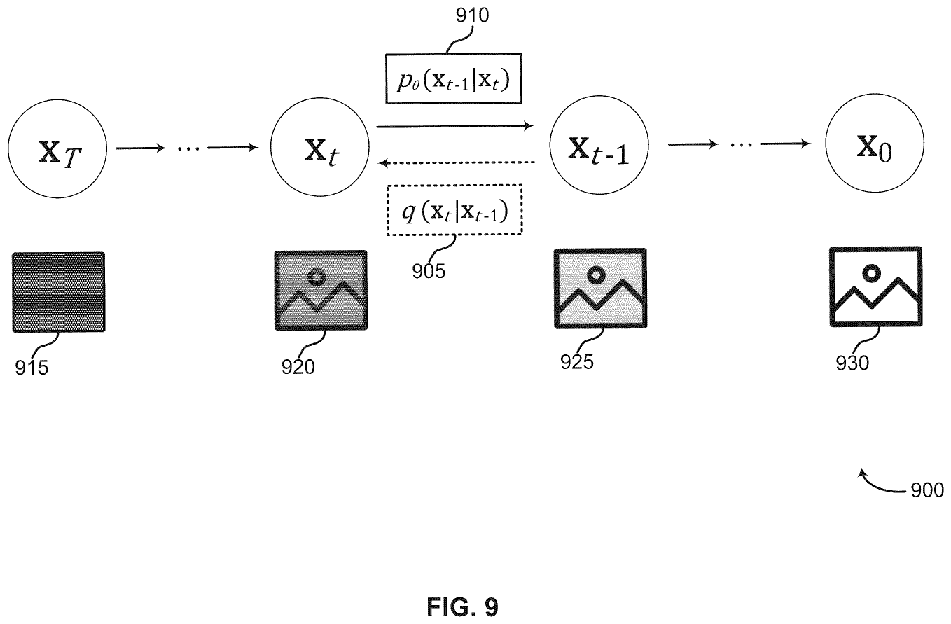

FIG. 9 shows a diffusion process 900 according to aspects of the present disclosure. In some examples, diffusion process 900 describes an operation of the machine learning model 1515 described with reference to FIG. 15, such as the reverse diffusion process 625 of guided diffusion model 600 described with reference to FIG. 6.

As described above with reference to FIG. 6, using a diffusion model can involve both a forward diffusion process 905 for adding noise to a media item (or features in a latent space) and a reverse diffusion process 910 for denoising the media item (or features) to obtain a denoised media item. The forward diffusion process 905 can be represented as q(xₜ|xₜ₋₁), and the reverse diffusion process 910 can be represented as p(xₜ₋₁|xₜ). In some cases, the forward diffusion process 905 is used during training to generate media items with successively greater noise, and a neural network is trained to perform the reverse diffusion process 910 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 910, the model begins with noisy data x_{T}, such as a noisy media item 915 and denoises the data to obtain the p(xₜ₋₁|xₜ). At each step t−1, the reverse diffusion process 910 takes xₜ, such as first intermediate media item 920, and t as input. Here, t represents a step in the sequence of transitions associated with different noise levels, The reverse diffusion process 910 outputs xₜ₋₁, such as second intermediate media item 925 iteratively until x-reverts back to x₀, the original media item 930. The reverse process can be represented as:

$${p}_{θ} ( {x}_{t - 1} \vert {x}_{t} ) : = N ( {x}_{t - 1} ; {μ}_{θ} ( {x}_{t} , t ) , {Σ}_{θ} ( {x}_{t} , t ) ) \qquad ( 3 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) \qquad ( 4 )$$

where p(x_{T})=N(x_{T}; 0,I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and \tilde{x} represents the generated item with high quality. Diffusion process is an example of, or includes aspects of, the corresponding element described with reference to FIGS. 2, 5-8, and 12-14.

Accordingly, an apparatus for response generation is described. One or more aspects of the apparatus include a memory component; a processing device coupled to the memory component, the processing device configured to perform operations comprising: obtaining an input prompt that includes an input media description; generating, using a language generation model, a text token based on the input prompt; generating, using a media generation model, a synthetic media based on the input prompt, wherein the synthetic media is generated independent of the language generation model and depicts a scene corresponding to the input image description; and generating a response to the input prompt based on the text token and the synthetic media.

In some aspects, the language generation model comprises a text transformer model. In some aspects, the media generation model comprises a diffusion model. In some aspects, the system comprises a fusion model incorporating the language generation model and the media generation model.

Some examples of the apparatus and system further include a media encoder configured to encode the input media to obtain an input media token. Some examples of the apparatus and system further include a text encoder configured to encode the input media description to obtain an input text token.

### Response Generation Process

The present disclosure describes systems and methods for response generation. Embodiments of the present disclosure include a response generation apparatus that extends use of a pretrained language generation model for a multimodal task. In some cases, the pretrained language generation model is able to preserve their language capabilities while integrating vision specific information. The response generation apparatus comprises a fusion model that uses a dual-tower design with modality-specific weights.

The fusion model retains language capabilities of a pre-trained language generation model while adapting the language generation model with multimodal generation capability. In some cases, the fusion model is used to freeze weights of the language generation model. By freezing weights of the language generation model, embodiments of the present disclosure are able to preserve inherent capabilities of the language generation model.

FIG. 10 shows an example of a method 1000 for response generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1005, the system obtains an input prompt that includes an input media description. In some cases, the operations of this step refer to, or may be performed by, a response generation apparatus as described with reference to FIG. 15.

For example, in some cases, the user interface of the response generation apparatus (such as response generation apparatus 1500 described with reference to FIG. 15) receives an input prompt from a user. In some examples, the input prompt comprises a media item. In some examples, the input prompt comprises a natural language-based prompt. In some examples, the input prompt comprises a media item and a natural language-based query associated with the media item that the user wants a response to. In some examples, the response generation apparatus receives the input prompt from a database or any other data source.

At operation 1010, the system generates, using a language generation model, a text token based on the input prompt. In some cases, the operations of this step refer to, or may be performed by, a language generation model as described with reference to FIG. 16.

An embodiment of the present disclosure includes a text encoder configured to tokenize an input text to generate a text token. In some cases, the language generation model is trained using an autoregressive modeling objective. The training objective for this autoregressive model involves minimizing the negative log-likelihood of the observed data. In some examples, the language generation model is trained to maximize the likelihood of a given sequence by predicting each token based on a preceding token.

$${ℒ}_{AR} = {𝔼}_{{x}^{txt} , c} [ - {\sum }_{i = 1}^{N} log {P}_{θ} ( {x}_{i}^{txt} \vert {x}_{< i}^{txt} , c ) ] \qquad ( 5 )$$

At operation 1015, the system generates, using a media generation model, a synthetic media based on the input prompt. In some cases the synthetic media is generated independent of the language generation model and depicts a scene corresponding to the input description. In some cases, the operations of this step refer to, or may be performed by, a media generation model as described with reference to FIG. 16. For example, a language generation model can generate the text token and a separate media generation model can generate the synthetic media (e.g., image) without sharing a joint attention layer.

According to an embodiment, a media encoder is configured to generate a latent representation corresponding to a media item. For example, an image encoder generates a latent representation for an input image. In some examples, the image encoder encodes the latent representations to generate an image token. In some examples, the image encoder is implemented as a linear patchify layer with a patch size of 2×2.

For instance, the media generation model comprises a diffusion network (such as the diffusion network described with reference to FIGS. 6-9). In some cases, the media generation model generates a media item by reversing a noise-adding process, i.e., from pure noise and progressively denoising until a clean image is formed. The media generation model learns a denoising function to predict and remove the noise added at each time step. The training objective minimizes the difference between the true noise and the predicted noise for noisy media item at different time steps. Further details regarding this operation are provided with reference to FIG. 11.

$${ℒ}_{DM} = {𝔼}_{x , ϵ \sim 𝒩 ( 0 , I ) , t} [ {‖ ϵ - {f}_{θ} ( {x}_{t}^{img} , t , c ) ‖}_{2}^{2} ] \qquad ( 6 )$$

At operation 1020, the system generates a response to the input prompt based on the text token and the synthetic media. In some cases, the operations of this step refer to, or may be performed by, a fusion model as described with reference to FIG. 16. In some cases the system generates a response to the input prompt by combining the synthetic media with text corresponding to the text token.

According to an embodiment, the response generation apparatus comprises a fusion model. The fusion model processes a combination of the text token and media token. In some cases, the media generation model processes a media token conditioned on a textual feature for media generation. Additionally, the media generation model extracts a feature for visual understanding while ensuring that the visual features can be effectively interpreted by the language generation model (i.e., frozen language generation model).

In some cases, an output of the language generation model (e.g., an output of the text block) and an output of the image generation model (e.g., an output of the vision block) is selectively combined to generate an output sequence of the block. In some cases, a text decoder and a media decoder generate the response based on the output sequence. For example, a linear classification head decodes a text embedding of the output sequence into a discrete token.

Additionally, a linear regression head converts an image embedding of the output sequence to a continuous latent. Subsequently, a decoder (e.g., a latent variational autoencoder (VAE) decoder) decodes the continuous latent to generate a pixel value. In some cases, the fusion model provides the synthetic image to the user via the user interface (such as the user interface described with reference to at least FIGS. 1-2) of the user device. Further details regarding generation of response are provided with reference to FIG. 11.

The present disclosure describes systems and methods for response generation. Embodiments of the present disclosure include a fusion model comprising a language generation model and a media generation model. In some cases, the fusion model adapts a pretrained language generation model for a vision task while preserving inherent language capabilities of the language generation model. For example, the fusion model processes an image input and a text input in a single model. In some examples, the response generation apparatus maintains a weight of the language generation model which enables preservation of the language knowledge of the language generation model. In some examples, a training component of the response generation apparatus provides a trainable parameter for the input image.

Accordingly, a method for response generation is described. One or more aspects of the method include obtaining an input prompt that includes an input media description; generating, using a language generation model, a text token based on the input prompt; generating, using a media generation model, a synthetic media based on the input prompt, wherein the synthetic media is generated independent of the language generation model and depicts a scene corresponding to the input description; and generating a response to the input prompt based on the text token and the synthetic media.

In some aspects, the input prompt further includes an input media, wherein the text token and the synthetic media are each based on both the input description and the input media. In some aspects, the response includes text based on the text token. In some aspects, the text token comprises a media insertion token.

Some examples of the method, apparatus, and non-transitory computer readable medium further include encoding, using a text encoder, the input media description to obtain an input text token. Some examples further include encoding, using a media encoder, the input media to obtain an input media token, wherein the text token and the synthetic media are each based on both the input text token and the input media token.

In some aspects, the language generation model is trained independent of the media generation model, and the media generation model is trained based on the language generation model. In some aspects, the synthetic media is generated based on a combined loss including a text-to-image loss and an image-to-text loss.

Additionally, a method for response generation is described. One or more aspects of the method include obtaining an input prompt that includes an input media; generating, using a language generation model, a text token based on the input prompt; generating, using a media generation model, a synthetic media based on the input prompt, wherein the synthetic media is generated independent of the language generation model and depicts an element of the input media; and generating a response to the input prompt based on the text token and the synthetic media, wherein the response comprises a description of the input media.

In some aspects, the input prompt further includes an input media description, wherein the text token and the synthetic media are each based on both the input media description and the input media. In some aspects, the response includes the synthetic media. In some aspects, the text token comprises a media insertion token.

Some examples of the method, apparatus, and non-transitory computer readable medium further include encoding, using a text encoder, the input media description to obtain an input text token. Some examples further include encoding, using a media encoder, the input media to obtain an input media token, wherein the text token and the synthetic media are each based on both the input text token and the input media token.

In some aspects, the language generation model is trained independent of the media generation model, and the media generation model is trained based on the language generation model. In some aspects, the synthetic media is generated based on a combined loss including a text-to-image loss and an image-to-text loss.

### Training the System

Embodiments of the present disclosure include a response generation apparatus that performs vision understanding. In some cases, a training component of the response generation apparatus creates an image understanding training dataset without introducing noise to the image data. In some cases, the training component uses the training dataset for training a unified model. By performing vision understanding without noise data, embodiments are able to enhance image generation and image understanding capabilities due to increased semantic visual representation.

The response generation apparatus of the present disclosure adapts a pretrained large language model to different modalities while retaining the language capability of the language generation model. In some cases, the training component provides for learning of semantic visual representation resulting in enhanced image generation and image understanding abilities. In some cases, by learning the semantic visual representation, embodiments provide for cross-task synergy resulting in increased image understanding and enhanced image generation quality. Additionally, in some cases, the response generation apparatus effectively aligns visual features with an additional pre-trained representation. By performing the alignment between different modalities, embodiments enable fast convergence of the fusion model.

In some cases, the language generation model is trained using an autoregressive modeling objective. For example, the joint probability of a sequence of language tokens

$${x}^{txt} = {x}_{1}^{txt} , {x}_{2}^{txt} , … , {x}_{N}^{txt}$$

is factorized as a product of conditional probabilities:

$${P}_{θ} ( {x}^{txt} \vert c ) = {\prod }_{i = 1}^{N} {P}_{θ} ( {x}_{i}^{txt} \vert {x}_{< i}^{txt} , c ) \qquad ( 7 )$$

where, c represents optional conditioning information. In some cases, the optional conditioning information includes extracted features from other modalities, e.g., an image representation, or a task-specific context. In some cases, a language generation model is trained without an additional conditioning (i.e., without c). As such, the prediction depends on a preceding token

$${x}_{< i}^{txt} .$$

In some cases, a training objective of the autoregressive model is to minimize the negative log-likelihood of the observed data:

$${ℒ}_{AR} = {𝔼}_{{x}^{txt} , c} [ - {\sum }_{i = 1}^{N} log {P}_{θ} ( {x}_{i}^{txt} \vert {x}_{< i}^{txt} , c ) ] \qquad ( 8 )$$

In some cases, the language generation model is able to extend their capability to multimodal tasks (e.g., conditional text generation, cross-modal understanding, etc.) by implementing conditioning information c.

FIG. 11 shows an example of training the fusion model according to aspects of the present disclosure. In one aspect, training process 1100 includes input text token 1105, input media token 1110, language generation model 1115, media generation model 1120, text token 1125, and media token 1130.

The present disclosure describes systems and methods for image generation. Embodiments of the present disclosure include a fusion model comprising a language generation model and an image generation model. In some cases, the fusion model adapts a pretrained language generation model (such as language generation model 1115) for a vision task while preserving inherent language capabilities of the language generation model using a dual-tower architecture (as described herein).

For example, the fusion model processes an image input (such as input media token 1110) and a text input (such as input text token 1105) in a single model. In some examples, the response generation apparatus maintains a weight of the language generation model 1115 which enables preservation of the language knowledge of the language generation model 1115. In some examples, a training component of the response generation apparatus provides a trainable parameter for the input media token 1110 (e.g., input image token).

In some cases, a text encoder (such as the text encoder described with reference to FIGS. 4 and 16) tokenizes a text input (such as the text input described with reference to FIG. 4) to generate input text token 1105. In some cases, a media encoder (such as the media encoder described with reference to FIGS. 4 and 16 or an image encoder) generates a latent representation corresponding to a media item. In some cases, the media encoder encodes the latent representations to generate input media token 1110. For example, the image encoder is implemented as a linear patchify layer with a patch size of 2×2. The fusion model processes the combined token, wherein the trainable parameters facilitate joint optimization for image understanding and image generation.

In some cases, the tokenize input embeddings are denoted as:

$${E}^{in} = \{ {e}_{1} , {e}_{2} , … , {e}_{M} \} \qquad ( 9 )$$

where token e₁ can be a text token or a vision token. The fusion model incorporates a new training weight with a pre-trained language generation model (e.g., a frozen language generation model 1115). By incorporating training weight along with the frozen language generation model, embodiments of the present disclosure are able to effectively process textual and visual modalities while retaining the knowledge of the language generation model 1115.

As shown in FIG. 11, the fusion model comprises a frozen text transformer block [symbol] ^{txt} and a trainable vision transformer block [symbol] ^{img} at each layer. Each of the text transformer block (corresponding to language generation model 1115) and the vision transformer block (corresponding to media generation model 1120) operate on the same input embedding Eⁱⁿ.

The output of the text transformer block is given as H^{txt} and the vision transformer block is given as H^{img}.

$${H}^{txt} = {ℱ}^{txt} ( {E}^{in} ) \qquad ( 10 )$$

$${H}^{img} = {ℱ}^{img} ( {E}^{in} ) \qquad ( 11 )$$

In some cases, media generation model 1120 processes input media token 1110 (e.g., an image token) conditioned on a textual feature for media (e.g., image) generation. Additionally, media generation model 1120 extracts a feature for visual understanding while ensuring that the visual features can be effectively interpreted by the frozen language generation model 1115.

In some cases, an output of the language generation model 1115 (e.g., an output of the text block) and an output of the media generation model 1120 (e.g., an output of the vision block) is selectively combined to generate an output sequence of the block:

$${H}^{out} = \{ {h}_{1} , {h}_{2} , … , {h}_{M} \} \qquad ( 12 )$$

$$where ,$$

$${h}_{i} = \{ \begin{matrix}{h}_{i}^{txt} , & if {x}_{i} ∈ {x}^{txt} , \\ {h}_{i}^{img} , & if {x}_{i} ∈ {x}^{img} .\end{matrix} \qquad ( 13 )$$

### Here,

$${h}_{i}^{txt}$$

### ∈H^{txt} and

$${h}_{i}^{img}$$

∈H^{img} are outputs or the text block and vision block, respectively, for the i-th token. For example, as indicated in FIG. 11, text token 1125 and media token 1130 include

$${h}_{i}^{txt} and {h}_{i}^{img} ,$$

respectively.

An embodiment of the present disclosure is configured to process an interleaved modality input. In case of the interleaved modality input, each of the input text token 1105 and input media token 1110 are provided as input to a text layer and a media layer (i.e., the text layer and the media layer corresponding to language generation model 1115 and media generation model 1120, respectively) to generate two sets of features (i.e., text token 1125 and media token 1130).

For instance, feature output from the text layer is denoted as txt^{t} and img^{t}. Additionally, for instance, feature output from the media layer is denoted as txtⁱ and imgⁱ. In some cases, the output from the layer of the fusion model is denoted as α*txt^{t}+γ*txtⁱ and β*img^{t}+δ*imgⁱ corresponding to the text layer and the media layer, respectively. Here, α, β, γ, δ are learnable parameters.

According to an embodiment of the present disclosure, each vision block is initialized by copying a parameter in a corresponding language transformed layer. In some examples, the language transformed layer comprises a self-attention layer, a multi-layer perceptron (MLP) layer, and two normalization layers.

In some cases, a linear classification head is used to decode the text embedding (text token 1125) into a discrete token. A linear regression head converts an image embedding (media token 1130) to a continuous latent. Subsequently, a latent VAE decoder decodes the continuous latent to generate a pixel value.

As described with reference to FIG. 11, at each layer of media generation model 1120, media token 1130 is generated by media generation model 1120 based on considering an input from the language generation model 1115 (i.e., at each layer of language generation tower). In some cases, language generation model 1115 is pretrained. For example, language generation model 1115 may be frozen and not trained. In some examples, at each layer, media generation tower (e.g., media generation model 1120) adapts media token 1130 to make it compatible with the frozen language generation tower.

In some cases, generation of the media token 1130 and text token 1125 is performed at each layer using media generation model 1120 and language generation model 1115, respectively. By enhancing the compatibility of the media generation model and the language generation model, embodiments of the present disclosure are able to ensure that the fusion model can understand the image content.

As shown with reference to FIG. 11, the media generation model 1120 (e.g., vision tower) is implemented based on a copied pretrained large language model (LLM). However, embodiments are not limited thereto, and the media generation model can conceptually be replaced with any pretrained Diffusion Transformer (DiT) model. Since the text layers in the language generation model and the vision layers in the media generation model (e.g., DiT) may be transformer-based, the text layer and the vision layer can be seamlessly combined when their input feature dimensions and output feature dimensions match. Similarly, each of the text layer and the vision layer can process both modalities simultaneously, with the output tokens selectively assigned to the corresponding modality inputs.

Input text token 1105 is an example of, or includes aspects of, the corresponding element described with reference to FIG. 4. Input media token 1110 is an example of, or includes aspects of, the corresponding element described with reference to FIG. 4.

Language generation model 1115 is an example of, or includes aspects of, the corresponding element described with reference to FIG. 4. Media generation model 1120 is an example of, or includes aspects of, the corresponding element described with reference to FIG. 4.

Text token 1125 is an example of, or includes aspects of, the corresponding element described with reference to FIG. 4. Media token 1130 is an example of, or includes aspects of, the corresponding element described with reference to FIG. 4.

A training component of the present disclosure is configured to compute a training objective for the fusion model. In some cases, the training component combines an autoregressive loss ( [symbol] _{AR}) and an image denoising loss ( [symbol] _{DM}) with the weighting coefficients λ_{AR} and λ_{DM}, respectively to generate the training objective.

$$ℒ = {λ}_{AR} \cdot {ℒ}_{AR} + {λ}_{DM} \cdot {ℒ}_{DM} \qquad ( 14 )$$

Embodiments of the present disclosure are configured to align vision features in the fusion model with a pretrained encoder. For example, the pretrained encoder (e.g., CLIP) is able to enhance the generation and understanding capabilities of the fusion model. In some examples, a vision feature from the 8th layer of the fusion model is aligned with the penultimate feature extracted from the pretrained encoder. For example, the dual tower architecture generates vision feature Hing that is projected using a trainable linear projection W to match feature dimension of the pretrained encoder.

In some examples, a training component computes an alignment loss using cosine distance between the projected feature and the feature of the pretrained encoder. The regularization loss is given as: [symbol] _{align}=1−cos(WH^{img}, H^{clip}), where H^{clip} is the vision feature extracted from the pretrained encoder, and cos(⋅,⋅) represents cosine similarity. By performing the alignment between the vision features and features of the pretrained encoder, embodiments of the present disclosure are able to accelerate the training process and enhance performance of image generation and image understanding.

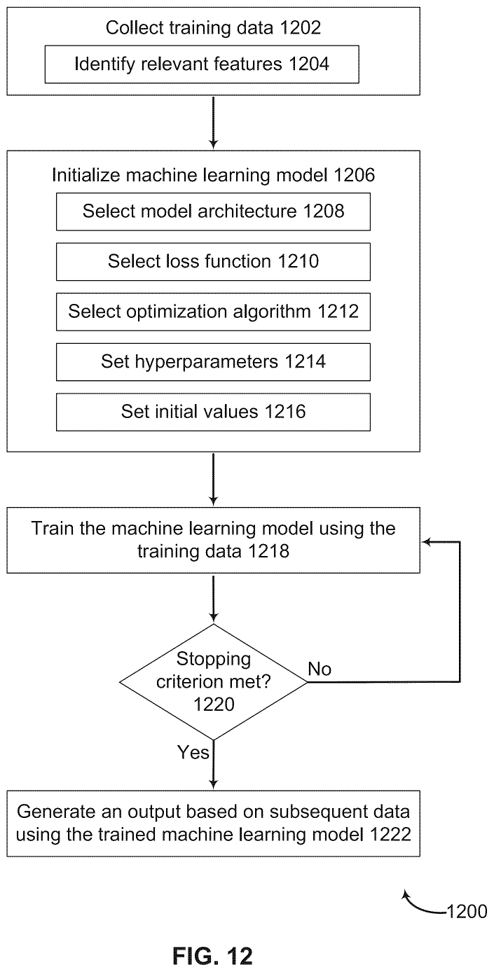

FIG. 12 shows an example of a method of training a machine learning model according to aspects of the present disclosure. FIG. 12 is a flow diagram depicting an algorithm as a step-by-step procedure 1200 in an example implementation of operations performable for training a machine-learning model. In some embodiments, the procedure 1200 describes an operation of the training component 1525 described for configuring the machine learning model 1515 as described with reference to FIG. 15. The procedure 1200 provides one or more examples of generating training data, use of the training data to train a machine-learning model, and use of the trained machine-learning model to perform a task.

To begin in this example, a machine-learning system collects training data (block 1202) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1204) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1206). Initialization of the machine-learning model includes selecting a model architecture (block 1208) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1210). The loss function is utilized to measure a difference between an output of the machine-learning model (i.e., predictions) and target values (e.g., as expressed by the training data) to be used to train the machine-learning model. Additionally, an optimization algorithm is selected (1212) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1214) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1218) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1220), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1220), the procedure 1200 continues training of the machine-learning model using the training data (block 1218) in this example.

If the stopping criterion is met (“yes” from decision block 1220), the trained machine-learning model is then utilized to generate an output based on subsequent data (block 1222). The trained machine-learning model, for instance, is trained to perform a task as described above and therefore once trained is configured to perform that task based on subsequent data received as an input and processed by the machine-learning model. The machine learning model is an example of, or includes aspects of, the media generation model described with reference to FIGS. 2, 5-9, 13, and 14.

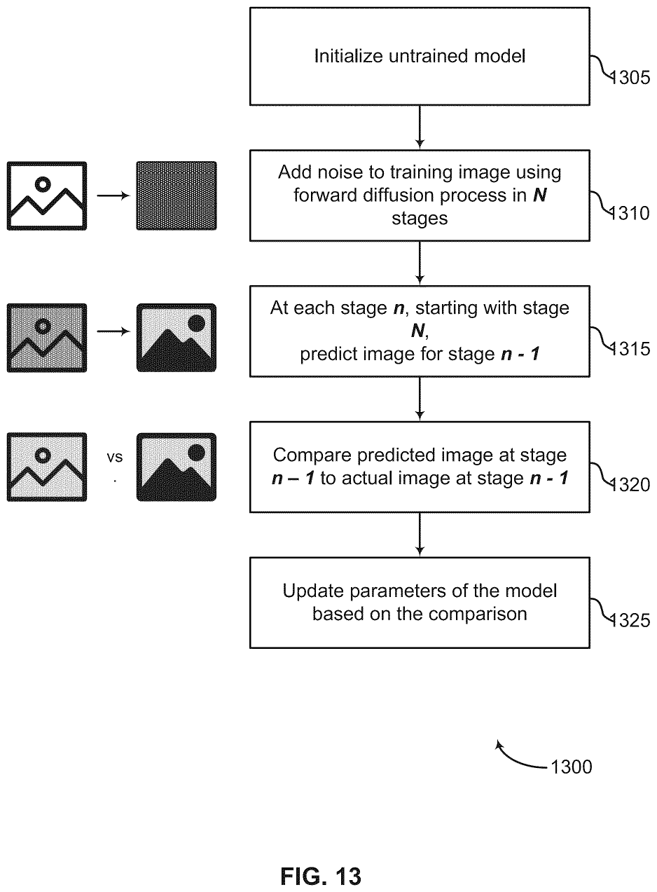

FIG. 13 shows an example of a method of training a diffusion model 1300 according to aspects of the present disclosure. In some embodiments, the method 1300 describes an operation of the training component 1525 described for configuring the machine learning model 1515 as described with reference to FIG. 15. The method 1300 represents an example for training a reverse diffusion process as described above with reference to FIGS. 6-9. In some examples, these operations are performed by a system including a processor executing a set of codes to control functional elements of an apparatus, such as the guided diffusion model described in FIG. 6.

Additionally or alternatively, certain processes of method 1300 may be performed using special-purpose hardware. Generally, these operations are performed according to the methods and processes described in accordance with aspects of the present disclosure. In some cases, the operations described herein are composed of various substeps or are performed in conjunction with other operations.

Referring to FIG. 13, according to some aspects, a training component (such as the training component 1525 described with reference to FIG. 15) trains a diffusion model (such as the media generation model described with reference to FIGS. 6-9) to generate an output.

At operation 1305, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1310, the system adds noise to a training image (or an additional training image) using a forward diffusion process (such as the forward diffusion process described with reference to FIG. 6) in N stages. In some cases, the operations of this step refer to, or may be performed by, a training component as described with reference to FIG. 15.

At operation 1315, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1320, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 1325, the system updates parameters of the model based on the comparison. For example, parameters of a U-Net may be updated using gradient descent. Time-dependent parameters of the Gaussian transitions can also be learned.

### Implementation and Evaluation

An exemplary embodiment of the present disclosure is configured to evaluate performance of the fusion model. In some examples, the fusion model uses LLAMA-3 model as a pretrained language generation model. For example, the fusion model uses Stable Diffusion 3 as the flow matching scheduler. In some examples, λ_{AR}=0.2 and λ_{DM}=1. In some examples, an AdamW optimizer is trained with β₁=0.9 and β₂=0.95. Subsequently, a training component of the present disclosure trains a linear warm-up scheduler, a maximum learning rate of lr=1×e⁻⁴, and DeepSpeed Stage 2 distributed training on H100 GPUs. The training component trains the fusion model with batches of 0.8M tokens for 100 k steps resulting in processing of 0.08 T tokens.

An exemplary embodiment of the present disclosure is configured to evaluate performance of the fusion model. For example, the performance of the fusion model is evaluated for tasks that reflect connection between multiple modalities, e.g., image understanding and image generation.

An exemplary embodiment evaluates the fusion model based on text-to-image generation. For example, the fusion model generates 30K images using randomly sampled prompts from a dataset. An FID score is used to evaluate quality of the image generation.

An exemplary embodiment evaluates the fusion model based on image captioning. For example, the fusion model generates 30K images from a dataset. A BLIP2-ITM score is used to evaluate quality of caption generation. In some examples, CIDEr score and BertScore are used for the evaluation.

An exemplary embodiment is configured to sample 0.08 T tokens per patch from an in-house dataset. In some examples, an image-caption pair is obtained by center-cropping and resizing an image to 256×256 pixels and pairing the resized image with a detailed caption. For example, InternVL-2.0 26B model is used to generate the detailed caption. For example, the image-caption pair is formatted for image-to-text generation (i.e., image understanding) and text-to-image generation (i.e., image generation).

An exemplary embodiment of the present disclosure performs an evaluation of the fusion model. In some examples, a dual tower architecture of the transformer block outperforms existing image generation and image understanding models. For example, the dual tower architecture is able to achieve a 23% lower FID score while maintaining the same number of training parameters.

According to an exemplary embodiment, the dual tower architecture is capable of performing a modality specific operation. For example, the dual tower architecture outperforms existing image generation and image understanding systems. In some examples, the dual tower architecture comprises a vision layer that generates a new QKV representation for an input text feature. Subsequently, the vision layer performs an attention operation between the image and the new text features. By generating new QKV representations for the input text features, embodiments of the present disclosure provide for enhanced flexibility in the dual tower architecture.

### Computing Device

Embodiments of the present disclosure include a fusion model for adapting a pretrained language generation model to a different modality. For example, the pretrained model is adapted while retaining the language capabilities of the language generation model. According to an embodiment, the fusion model implements a dual tower architecture in the transformer block. In some cases, the dual tower architecture enables processing of a visual feature via a trainable vision tower with separate weights while maintaining the weights of the language generation model. By implementing the dual architecture, embodiments of the present disclosure are able to enhance an image understanding task resulting in improved quality of image generation. By reducing the noise in training image data, embodiments are able to enhance performance of the image understanding and image generation tasks.

FIG. 14 shows an example of a computing device according to aspects of the present disclosure. The computing device 1400 may be an example of the response generation apparatus 1500 described with reference to FIG. 15. In one aspect, computing device 1400 includes processor(s) 1405, memory subsystem 1410, communication interface 1415, I/O interface 1420, user interface component(s) 1425, and channel 1430.

In some embodiments, computing device 1400 is an example of, or includes aspects of, the machine learning model of FIG. 15. In some embodiments, computing device 1400 includes one or more processors 1405 that can execute instructions stored in memory subsystem 1410 to perform media generation.

According to some aspects, computing device 1400 includes one or more processors 1405. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1410 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1415 operates at a boundary between communicating entities (such as computing device 1400, one or more user devices, a cloud, and one or more databases) and channel 1430 and can record and process communications. In some cases, communication interface 1415 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1420 is controlled by an I/O controller to manage input and output signals for computing device 1400. In some cases, I/O interface 1420 manages peripherals not integrated into computing device 1400. In some cases, I/O interface 1420 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1420 or via hardware components controlled by the I/O controller.

According to some aspects, user interface component(s) 1425 enable a user to interact with computing device 1400. In some cases, user interface component(s) 1425 include an audio device, such as an external speaker system, an external display device such as a display screen, an input device (e.g., a remote-control device interfaced with a user interface directly or through the I/O controller), or a combination thereof. In some cases, user interface component(s) 1425 include a GUI.

FIG. 15 shows an example of a response generation apparatus 1500 according to aspects of the present disclosure. Response generation apparatus 1500 is an example of, or includes aspects of, the corresponding element described with reference to FIGS. 1-5. In one aspect, response generation apparatus 1500 includes processor unit 1505, memory unit 1510, I/O module 1520, and training component 1525. Training component 1525 updates parameters of the machine learning model 1515 stored in memory unit 1510. In some examples, the training component 1525 is located outside the response generation apparatus 1500.

According to some aspects, response generation apparatus 1500 obtains an input prompt that includes an input media description. In some aspects, the input prompt further includes an input media, where the text token and the synthetic media are each based on both the input description and the input media.

According to some aspects, response generation apparatus 1500 obtains an input prompt that includes an input media. In some aspects, the input prompt further includes an input media description, where the text token and the synthetic media are each based on both the input media description and the input media.

According to some aspects, processor unit 1505 comprises a processing device coupled to the memory component. Processor unit 1505 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1505 is configured to operate a memory array using a memory controller. In other cases, a memory controller is integrated into processor unit 1505. In some cases, processor unit 1505 is configured to execute computer-readable instructions stored in memory unit 1510 to perform various functions. In some aspects, processor unit 1505 includes special purpose components for modem processing, baseband processing, digital signal processing, or transmission processing. According to some aspects, processor unit 1505 comprises one or more processors described with reference to FIG. 14.

Memory unit 1510 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1505 to perform various functions described herein.

In some cases, memory unit 1510 includes a basic input/output system (BIOS) that controls basic hardware or software operations, such as an interaction with peripheral components or devices. In some cases, memory unit 1510 includes a memory controller that operates memory cells of memory unit 1510. For example, the memory controller may include a row decoder, column decoder, or both. In some cases, memory cells within memory unit 1510 store information in the form of a logical state. According to some aspects, memory unit 1510 is an example of the memory subsystem 1410 described with reference to FIG. 14.

According to some aspects, response generation apparatus 1500 uses one or more processors of processor unit 1505 to execute instructions stored in memory unit 1510 to perform functions described herein. For example, the response generation apparatus 1500 may obtain an input prompt that includes an input media description; generate, using a language generation model, a text token based on the input prompt; generate, using a media generation model, a synthetic media based on the input prompt, wherein the synthetic media is generated independent of the language generation model and depicts a scene corresponding to the input description; and generate a response to the input prompt based on the text token and the synthetic media.

In one aspect, memory unit 1510 includes machine learning model 1515 trained to obtain an input prompt that includes an input media description; generate, using a language generation model, a text token based on the input prompt; generate, using a media generation model, a synthetic media based on the input prompt, wherein the synthetic media is generated independent of the language generation model and depicts a scene corresponding to the input description; and generate a response to the input prompt based on the text token and the synthetic media.

For example, after training, the machine learning model 1515 may perform inferencing operations as described with reference to FIGS. 1-3 to obtain an input prompt that includes an input media description; generate, using a language generation model, a text token based on the input prompt; generate, using a media generation model, a synthetic media based on the input prompt, wherein the synthetic media is generated independent of the language generation model and depicts a scene corresponding to the input description; and generate a response to the input prompt based on the text token and the synthetic media.

In some embodiments, the machine learning model 1515 is an Artificial neural network (ANN) comprising a plurality of networks including the guided diffusion model described with reference to FIG. 6, the diffusion transformer architecture described with reference to FIG. 7, and the U-Net described with reference to FIG. 8. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of machine learning model 1515 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

I/O module 1520 receives inputs from and transmits outputs of the response generation apparatus 1500 to other devices or users. For example, I/O module 1520 receives inputs for the machine learning model 1515 and transmits outputs of the machine learning model 1515. According to some aspects, I/O module 1520 is an example of the I/O interface 1420 described with reference to FIG. 14.

Training component 1525 may train the machine learning model 1515. For example, parameters of the machine learning model 1515 can be learned or estimated from training data and then used to make predictions or perform tasks based on learned patterns and relationships in the data. In some examples, the parameters are adjusted during the training process to minimize a loss function or maximize a performance metric (e.g., as described with reference to FIG. 12). The goal of the training process may be to find optimal values for the parameters that allow the image generation model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning model 1515 can be used to make predictions on new, unseen data (i.e., during inference). Machine learning model 1515 is an example of, or includes aspects of, the corresponding element described with reference to FIG. 16.

FIG. 16 shows an example of a machine learning model 1600 according to aspects of the present disclosure. Machine learning model 1600 is an example of, or includes aspects of, the corresponding element described with reference to FIG. 15. In one aspect, machine learning model 1600 includes text encoder 1605, media encoder 1610, fusion model 1615, text decoder 1630, and media decoder 1635.

According to some aspects, text encoder 1605 encodes the input media description to obtain an input text token. According to some aspects, media encoder 1610 encodes the input media to obtain an input media token, where the text token and the synthetic media are each based on both the input text token and the input media token.

According to some aspects, fusion model 1615 generates a response to the input prompt based on the text token and the synthetic media. In some aspects, the response includes text based on the text token. In some aspects, the text token includes a media insertion token.

According to some aspects, fusion model 1615 generates a response to the input prompt based on the text token and the synthetic media, where the response includes a description of the input media. In some aspects, the response includes the synthetic media.

According to some aspects, fusion model 1615 comprises generating a response to the input prompt based on the text token and the synthetic media. In some aspects, the system includes a fusion model 1615 incorporating the language generation model 1620 and the media generation model 1625. For instance, fusion model 1615 includes language generation model 1620 and media generation model 1625.

According to some aspects, language generation model 1620 generates a text token based on the input prompt. In some aspects, the language generation model 1620 is trained independent of the media generation model 1625, and the media generation model 1625 is trained based on the language generation model 1620. In some aspects, the language generation model 1620 includes a text transformer model. For instance, language generation model 1620 may include a transformer model as described with reference to FIG. 5.

According to some aspects, media generation model 1625 generates a synthetic media based on the input prompt, where the synthetic media is generated independent of the language generation model 1620 and depicts a scene corresponding to the input description.

According to some aspects, media generation model 1625 generates a synthetic media based on the input prompt, where the synthetic media is generated independent of the language generation model 1620 and depicts an element of the input media. In some aspects, the media generation model 1625 includes a diffusion model.

As used herein, a multi-layer perceptron (MLP) refers to a type of artificial neural network comprising an input layer, one or more hidden layers, and an output layer, wherein each layer includes a plurality of interconnected neurons. Each neuron in a given layer applies a weighted sum operation to received inputs and processes the result using a non-linear activation function, such as a rectified linear unit (ReLU), sigmoid, or hyperbolic tangent (tanh) function. The MLP is trained using backpropagation, wherein weight values are iteratively updated based on a loss function to minimize prediction error.

In certain embodiments, the MLP is employed in an image generation pipeline, wherein it receives feature representations of input data and generates pixel values or latent space embeddings that define an output image. The MLP may function as a discriminator in a generative adversarial network (GAN) framework, classifying images as real or synthetic. Additionally, the MLP may be integrated into a transformer-based or diffusion-based architecture to refine generated image outputs. The present disclosure contemplates variations in MLP architecture, including modifications to layer depth, neuron connectivity, and activation functions, to enhance model performance for image synthesis tasks.

As described herein, a linear regression head refers to a computational module that applies a linear transformation to input features to generate a continuous output. The linear regression head may be used in predictive modeling tasks to estimate a target value based on learned weights and biases. The linear regression head may be integrated into a larger machine learning model, such as a neural network or a diffusion network, to refine or interpret feature representations for tasks including media synthesis, parameter estimation, or structured data analysis.

In some cases, a variational autoencoder (VAE) decoder is a neural network component that reconstructs data from a learned latent representation. Given a latent code sampled from a probabilistic distribution, the decoder applies a series of transformations to generate an output resembling the original input data, such as an image, video, or other media items. In diffusion networks or other generative architectures, the VAE decoder may contribute to structured media generation by enforcing smooth and continuous representations in the latent space.

As described herein, a linear classification head is a computational module that maps input features to categorical labels using a linear transformation followed by a decision function, such as a softmax or thresholding operation. The linear classification head may be used in neural networks for tasks such as object recognition, content classification, or structured data categorization. The linear classification head may be trained in conjunction with feature extractors, including diffusion networks or other generative models, to facilitate media analysis, labeling, or content-based decision-making.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input prompt that includes an input media description;
generating, using a language generation model, a text token based on the input prompt;
generating, using a media generation model, a synthetic media based on the input prompt, wherein the synthetic media depicts a scene corresponding to the input description; and
generating a response to the input prompt by combining the synthetic media with text corresponding to the text token.

2. The method of claim 1, wherein:
the input prompt further includes an input media, wherein the text token and the synthetic media are each based on both the input description and the input media.

3. The method of claim 2, further comprising:
encoding, using a text encoder, the input media description to obtain an input text token; and
encoding, using a media encoder, the input media to obtain an input media token, wherein the text token and the synthetic media are each based on both the input text token and the input media token.

4. The method of claim 1, wherein:
the synthetic media is generated based on a combined loss including a text-to-image loss and an image-to-text loss.

5. The method of claim 1, wherein:
the response includes text based on the text token.

6. The method of claim 1, wherein:
the language generation model is trained independent of the media generation model, and the media generation model is trained based on the language generation model.

7. The method of claim 1, wherein:
the synthetic media is generated independent of the language generation model.

8. A non-transitory computer readable medium storing code for response generation, the code comprising instructions that, when executed by at least one processor, causes the at least one processor to perform operations comprising:
obtaining an input prompt that includes an input media;
generating, using a language generation model, a text token based on the input prompt;
generating, using a media generation model, a synthetic media based on the input prompt, wherein the synthetic media depicts an element of the input media; and
generating a response to the input prompt based on the text token and the synthetic media, wherein the response comprises a description of the input media.

9. The non-transitory computer readable medium of claim 8, wherein:
the input prompt further includes an input media description, wherein the text token and the synthetic media are each based on both the input media description and the input media.

10. The non-transitory computer readable medium of claim 9, the code further comprising instructions that, when executed by the at least one processor, causes the at least one processor to perform operations comprising:
encoding, using a text encoder, the input media description to obtain an input text token; and
encoding, using a media encoder, the input media to obtain an input media token, wherein the text token and the synthetic media are each based on both the input text token and the input media token.

11. The non-transitory computer readable medium of claim 8, wherein:
the language generation model is trained independent of the media generation model, and the media generation model is trained based on the language generation model.

12. The non-transitory computer readable medium of claim 8, wherein:
the synthetic media is generated based on a combined loss including a text-to-image loss and an image-to-text loss.

13. The non-transitory computer readable medium of claim 8, wherein:
the response includes the synthetic media.

14. The non-transitory computer readable medium of claim 8, wherein:
the text token comprises a media insertion token.

15. A system comprising:
a memory component; and
a processing device coupled to the memory component, the processing device configured to perform operations comprising:
obtaining an input prompt that includes an input media description;
generating, using a language generation model, a text token based on the input prompt;
generating, using a media generation model, a synthetic media based on the input prompt, wherein the synthetic media depicts a scene corresponding to the input description; and
generating a response to the input prompt by combining the synthetic media with text corresponding to the text token.

16. The system of claim 15, wherein:
the language generation model comprises a text transformer model.

17. The system of claim 15, wherein:
the media generation model comprises a diffusion model.

18. The system of claim 15, wherein:
the system comprises a fusion model incorporating the language generation model and the media generation model.

19. The system of claim 15, further comprising:
a media encoder configured to encode the input media to obtain an input media token.

20. The system of claim 15, further comprising:
a text encoder configured to encode the input media description to obtain an input text token.
